(19) United States
(12) Patent Application Publication
(10) Pub. No.: US 2023/0352655 A1
(43) Pub. Date: Nov. 2, 2023

(54) ELECTRODE, SECONDARY BATTERY, MOVING VEHICLE, AND ELECTRONIC DEVICE

(71) Applicant: SEMICONDUCTOR ENERGY LABORATORY CO., LTD., Atsugi-shi, Kanagawa-ken (JP)

(72) Inventors: Kunihiko SUZUKI, Isehara, Kanagawa (JP); Kengo AKIMOTO, Isehara, Kanagawa (JP); Marina SUGANUMA, Atsugi, Kanagawa (JP); Yuji IWAKI, Isehara, Kanagawa (JP); Kazutaka KURIKI, Ebina, Kanagawa (JP); Taisuke NAKAO, Atsugi, Kanagawa (JP); Shunpei YAMAZAKI, Setagaya, Tokyo (JP)

(21) Appl. No.: 18/003,514

(22) PCT Filed: Jun. 29, 2021
(86) PCT No.: PCT/IB2021/055785

§ 371 Date: Dec. 28, 2022

(30) Foreign Application Priority Data
Jul. 10, 2020 (JP) 2020-119232

(51) Int. Cl. H01M 4/36; H01M 4/583; H01M 4/38

(52) U.S. Cl. CPC H01M 4/364; H01M 4/583; H01M 4/386; H01M 2220/20

(57) ABSTRACT

An electrode with excellent characteristics is provided. An active material with excellent characteristics is provided. A novel silicon material is provided. An electrode includes a plurality of particles and a graphene compound. At least part of the surface of each of the plurality of particles is terminated by a functional group containing oxygen, the graphene compound contains the plurality of particles so as to cover the surrounding of the plurality of particles, and the graphene compound is graphene containing at least one of a carbon atom terminated by a hydrogen atom and a carbon atom terminated by a fluorine atom in a two-dimensional structure formed with a six-membered ring of carbon.

### TECHNICAL FIELD

One embodiment of the present invention relates to an electrode and a method for manufacturing the electrode. Another embodiment of the present invention relates to an active material included in an electrode and a method for manufacturing the active material. Another embodiment of the present invention relates to a secondary battery and a method for manufacturing the secondary battery. Another embodiment of the present invention relates to a moving vehicle such as a vehicle, a portable information terminal, an electronic device, and the like that each include a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

It is important for secondary batteries to have high capacity as well as their stability. A silicon-based material has high capacity and is used as an active material of a secondary battery. A silicon material can be characterized by a chemical shift value obtained from an NMR spectrum (Patent Document 1).

Fluorine has high electronegativity and its reactivity has been studied variously. Non-Patent Document 1 describes a reaction of a compound containing fluorine.

### REFERENCE

### Patent Document

[Patent Document 1] Japanese Published Patent Application No. 2015-156355

### Non-Patent Document

[Non-Patent Document 1] J. M. Sangster and A. D. Pelton, “Critical Coupled Evaluation of Phase Diagrams and Thermodynamic Properties of Binary and Ternary Alkali Salt Systems”, American Ceramic Society; Westerville, Ohio; pp. 4-231 (1987).

### SUMMARY OF THE INVENTION

### Problems to be Solved by the Invention

Capacity of secondary batteries used in moving vehicles such as electric vehicles or hybrid vehicles need to be increased for longer driving ranges.

Furthermore, portable terminals and the like have more and more functions, resulting in an increase in power consumption. In addition, reductions in size and weight of secondary batteries used in portable terminals and the like are demanded. Therefore, secondary batteries used for portable terminals are desired to have higher capacity.

For example, an electrode of a secondary battery is formed using materials such as an active material, a conductive agent, and a binder. As the proportion of a material that contributes to charge-discharge capacity, for example, an active material, becomes higher, a secondary battery can have increased capacity. When an electrode includes a conductive agent, the conductivity of the electrode is increased and excellent output characteristics can be obtained. Repeated expansion and contraction of an active material in charging and discharging of a secondary battery may cause collapse of the active material, short-circuiting of a conductive path, or the like in the electrode. In such a case, one or both of a conductive agent and a binder included in an electrode can suppress at least one of the collapse of an active material and short-circuiting of a conductive path. Meanwhile, the use of one or both of a conductive agent and a binder lowers the proportion of an active material, which might decrease the capacity of a secondary battery in some cases.

An object of one embodiment of the present invention is to provide an electrode with excellent characteristics. Another object of one embodiment of the present invention is to provide an active material with excellent characteristics. Another object of one embodiment of the present invention is to provide a novel silicon material. Another object of one embodiment of the present invention is to provide a novel electrode.

Another object of one embodiment of the present invention is to provide a durable negative electrode. Another object of one embodiment of the present invention is to provide a durable positive electrode. Another object of one embodiment of the present invention is to provide a negative electrode with little deterioration. Another object of one embodiment of the present invention is to provide a positive electrode with high capacity.

Another object of one embodiment of the present invention is to provide a secondary battery with little deterioration. Another object of one embodiment of the present invention is to provide a highly safe secondary battery. Another object of one embodiment of the present invention is to provide a secondary battery with high energy density. Another object of one embodiment of the present invention is to provide a novel secondary battery.

Another object of one embodiment of the present invention is to provide a novel material, novel active material particles, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

In an electrode including a particle and a material having a sheet-like shape, the material having a sheet-like shape is curved so as to be close to the particle by an intermolecular force such as London dispersion force.

An electrode of one embodiment of the present invention includes a particle and a material having a sheet-like shape, and the particle has a region that is terminated by a functional group containing oxygen.

A particle included in the electrode of one embodiment of the present invention further preferably includes a region that is terminated by a functional group containing oxygen and hydrogen. Examples of the functional group containing oxygen and hydrogen include a hydroxy group, a carboxy group, and a functional group containing a hydroxy group.

The material having a sheet-like shape includes a first region and the first region is preferably terminated by a hydrogen atom. The first region is, for example, a region including one atom that can be bonded to hydrogen and a hydrogen atom bonded to the atom. Alternatively, the first region is, for example, a region including a plurality of atoms that can be bonded to hydrogen.

A hydrogen bond can be formed between the hydrogen atom in the first region and the oxygen atom contained in the functional group terminating the particle.

The material having a sheet-like shape preferably clings to the active material. The phrase “the material having a sheet-like shape clings to the active material” indicates that the material having a sheet-like shape is placed so as to cover part of the active material or stick to the surface of the active material, for example. The material having a sheet-like shape and the surface of the active material preferably have an area in which they are in surface contact with each other. Alternatively, the material having a sheet-like shape preferably covers part of the active material to make a surface contact.

In addition, the phrase “the material having a sheet-like shape clings to the active material” indicates that the material having a sheet-like shape preferably overlaps at least part of the active material. The shape of a graphene compound preferably conforms to at least part of the shape of the active material. The shape of the active material indicates, for example, unevenness of a single active material particle or unevenness formed by a plurality of active material particles. In addition, the material having a sheet-like shape preferably surrounds at least part of the active material.

The phrase “the material having a sheet-like shape clings to an object” indicates, for example, that the material having a sheet-like shape is placed so as to cover part of an object or so as to stick to the surface of an object. The material having a sheet-like shape and the surface of the object preferably have an area in which they are in surface contact with each other. Alternatively, the material having a sheet-like shape preferably covers part of the object to make a surface contact.

In addition, a case where an active material layer is provided over a current collector is described. The active material layer includes, for example, an active material and a material having a sheet-like shape. In the case where an active material layer is provided over a current collector, the material having a sheet-like shape clings to the surface of an active material particle and the surface of the current collector in some cases, for example.

The material having a sheet-like shape is curved so as to be close to the particle by an intermolecular force, and thus can cling to the particle due to a hydrogen bond. Note that the material having a sheet-like shape preferably has a plurality of regions terminated by hydrogen atoms in a sheet plane. The sheet plane has a plane facing a particle and a plane on the back thereof. In the regions terminated by hydrogen atoms, the hydrogen atoms terminating atoms in the regions are preferably provided in the plane facing the particle, for example. The plurality of regions terminated by hydrogen atoms are widely provided across the sheet plane, so that the area where the material having a sheet-like shape clings to the particle can be increased. In addition, the above-described material having a sheet-like shape has hydrogen bond regions, and the hydrogen bond regions may be localized and distributed. In such a distribution, an oxygen atom contained in a functional group terminating the particle and the hydrogen-bond region can cling to each other more closely by an intermolecular force or the like.

Alternatively, the first region may be terminated with a functional group containing oxygen. Examples of the functional group containing oxygen include a hydroxy group, an epoxy group, and a carboxy group. A hydrogen bond contained in a hydroxy group, a carboxy group, and the like can form a hydrogen bond with an oxygen atom contained in the functional group terminating the particle. In addition, an oxygen atom contained in a hydroxy group, an epoxy group, and a carboxy group can form a hydrogen bond with a hydrogen atom of the functional group terminating the particle.

In the case where the material having a sheet-like shape includes a second region that is terminated by a fluorine atom, the fluorine atom included in the second region and a hydrogen atom contained in the functional group terminating the particle can form a hydrogen bond. Accordingly, the material having a sheet-like shape clings to the particle more easily.

The first region includes a vacancy formed in the sheet plane and the vacancy is formed with a plurality of atoms bonded in a ring and atoms terminating the plurality of atoms. The plurality of atoms may be terminated by functional groups. Here, “forming a vacancy” indicates, for example, atoms around an opening, atoms on end portions of the opening, and the like.

A particle included in an electrode of one embodiment of the present invention preferably functions as, for example, an active material. As the particle included in the electrode of one embodiment of the present invention, a material functioning as an active material can be used. Alternatively, the particle included in the electrode of one embodiment of the present invention preferably contains a material functioning as an active material, for example. A material having a sheet-like shape included in the electrode of one embodiment of the present invention preferably functions as a conductive agent, for example. One embodiment of the present invention can provide an electrode having high conductivity, because a conductive agent can cling to an active material by a hydrogen bond.

The material having a sheet-like shape clings to an active material, whereby an collapse of the electrode or the like can be prevented. Moreover, the material having a sheet-like shape can cling to a plurality of active materials. The material having a sheet-like shape and the surface of the active material preferably have a surface contact area with each other. Alternatively, the material having a sheet-like shape preferably covers part of a surface of the active material so as to make a surface contact. In the case where a material with a large change in volume in charging and discharging, e.g., silicon, is used as the active material, the adhesion between the active material and the conductive agent, between the plurality of active materials, and the like is gradually weakened due to repeated charging and discharging, which might cause a collapse of the electrode or the like. According to one embodiment of the present invention, an electrode that is prevented from collapsing due to repeated charging and discharging, has stable characteristics, and high reliability, can be provided. Silicon has an extremely high theoretical capacity of 4000 mAh/g or higher and can increase the energy density of a secondary battery. By using a material containing silicon as a particle of one embodiment of the present invention, a high-reliable secondary battery that has a high energy density and has stable characteristics in repeated charging and discharging can be provided.

A particle of one embodiment of the present invention contains a silicon atom terminated by a hydroxy group. A particle of another embodiment of the present invention includes silicon and at least part of the surface of the particle is terminated with a hydroxy group. A particle of another embodiment of the present invention is a silicon compound at least part of the surface of which is terminated by a hydroxy group. A particle of another embodiment of the present invention is silicon at least part of the surface of which is terminated by a hydroxy group.

A particle of another embodiment of the present invention includes a first region containing silicon, and at least part of a surface of the first region is covered with silicon oxide. At least part of the surface of the silicon oxide includes silicon that is terminated by a hydroxy group. In the case where the silicon oxide has a film state, the thickness thereof is greater than or equal to 0.3 nm, greater than or equal to 0.5 nm, or greater than or equal to 0.8 nm, and less than or equal to 30 nm or less than or equal to 10 nm, for example.

A particle of another embodiment of the present invention includes a first region including a first metal, and at least part of the surface of the first region is covered with an oxide of the first metal. In addition, at least part of the surface of the oxide includes a first metal that is terminated by a hydroxy group. For example, one or more selected from tin, gallium, aluminum, germanium, lead, antimony, bismuth, silver, zinc, indium, and the like can be used as the first metal. In the case where the oxide has a film state, the thickness thereof is greater than or equal to 0.3 nm, greater than or equal to 0.5 nm, or greater than or equal to 0.8 nm, and less than or equal to 30 nm or less than or equal to 10 nm, for example.

A graphene compound is preferably used as the material having a sheet-like shape. A preferred example of the graphene compound is graphene in which a carbon atom in a sheet plane is terminated by an atom or a functional group other than carbon.

Graphene has a structure in which an edge is terminated by hydrogen. A sheet of graphene has a two-dimensional structure which is formed with a six-membered ring of carbon. When a defect or a vacancy is formed in the two-dimensional structure, a carbon atom in the vicinity of the defect and a carbon atom included in the vacancy are terminated by atoms in various functional groups, a hydrogen atom, a fluorine atom, or the like in some cases.

In one embodiment of the present invention, one or both of a defect and a vacancy are formed in graphene, and one or more of carbon atoms in the vicinity of the defect and carbon atoms forming the vacancy are terminated by a hydrogen atom, a fluorine atom, a functional group containing one or more of a hydrogen atom and a fluorine atom, a functional group containing oxygen, or the like, whereby graphene can cling to a particle included in the electrode. The defect and the vacancy formed in graphene are preferably formed in amount that does not notably decrease the conductivity of the whole graphene. Here, “forming a vacancy” indicates, for example, atoms around an opening, atoms on end portions of the opening, and the like.

A graphene compound of one embodiment of the present invention includes a vacancy formed with a many-membered ring such as a 7- or more-membered ring composed of carbon atoms, preferably an 18- or more-membered ring composed of carbon atoms, further preferably a 22- or more-membered ring composed of carbon atoms. One of carbon atoms in the many-membered ring is terminated by a hydrogen atom. Moreover, in one embodiment of the present invention, one carbon atom in the many-membered ring is terminated by a hydrogen atom, and another carbon atom in the many-membered ring is terminated by a fluorine atom. Furthermore, in one embodiment of the present invention, the number of carbon atoms in the many-numbered ring that are terminated by fluorine is less than 40% of the number of carbon atoms that are terminated by hydrogen atoms.

A graphene compound of one embodiment of the present invention includes a vacancy, and the vacancy is formed with a plurality of carbon atoms bonded to each other in a ring, atoms or functional groups terminating the plurality of carbon atoms. One or more of the plurality of carbon atoms bonded to each other in a ring may be substituted by any of a Group 13 element such as boron, a Group 15 element such as nitrogen, and a Group 16 element such as oxygen.

In the graphene compound of one embodiment of the present invention, a carbon atom other than the carbon atom at the edge is preferably terminated by a hydrogen atom, a fluorine atom, a functional group containing at least one of a hydrogen atom and a fluorine atom, a functional group containing oxygen, or the like. In addition, for example, in the graphene compound of one embodiment of the present invention, a carbon atom near the center of a plane of graphene is preferably terminated by one or more selected from a hydrogen atom, a fluorine atom, a functional group containing one or more of a hydrogen atom and a fluorine atom, a functional group containing oxygen, and the like.

One embodiment of the present invention is an electrode including a particle containing silicon and a graphene compound. At least part of the surface of the particle is terminated by a functional group containing oxygen, the graphene compound clings to the particle, and the graphene compound is graphene containing at least one of a carbon atom terminated by a hydrogen atom and a carbon atom terminated by a fluorine atom in a plane of the graphene.

Another embodiment of the present invention is an electrode including a plurality of particles and a graphene compound. At least part of the surface of each of the plurality of particles is terminated by a functional group containing oxygen, the graphene compound contains the plurality of particles so as to cover the surrounding of the plurality of particles, and the graphene compound is graphene containing at least one of a carbon atom terminated by a hydrogen atom and a carbon atom terminated by a fluorine atom in a plane of the graphene.

Another embodiment of the present invention is an electrode including a plurality of particles and a graphene compound. At least part of the surface of each of the plurality of particles is terminated by a functional group containing oxygen, the graphene compound has a pouch-like shape containing the plurality of particles, and the graphene compound is graphene containing at least one of a carbon atom terminated by a hydrogen atom and a carbon atom terminated by a fluorine atom in a plane of the graphene.

Another embodiment of the present invention is an electrode including a particle containing silicon and a graphene compound. At least part of the surface of the particle is terminated by a functional group containing oxygen, the graphene compound clings to the particle, and the graphene compound is graphene containing at least one of a carbon atom terminated by a hydrogen atom and a carbon atom terminated by a fluorine atom in a two-dimensional structure formed with a six-membered ring of carbon.

Another embodiment of the present invention is an electrode including a plurality of particles and a graphene compound. At least part of the surface of each of the plurality of particles is terminated by a functional group containing oxygen, the graphene compound contains the plurality of particles so as to cover the surrounding of the plurality of particles, and the graphene compound is graphene containing at least one of a carbon atom terminated by a hydrogen atom and a carbon atom terminated by a fluorine atom in a two-dimensional structure formed with a six-membered ring of carbon.

Another embodiment of the present invention is an electrode including a plurality of particles and a graphene compound. At least part of the surface of each of the plurality of particles is terminated by a functional group containing oxygen, the graphene compound has a pouch-like shape containing the plurality of particles, and the graphene compound is graphene containing at least one of a carbon atom terminated by a hydrogen atom and a carbon atom terminated by a fluorine atom in a two-dimensional structure formed with a six-membered ring of carbon.

In the above description, the functional group is preferably a hydroxy group, an epoxy group, or a carboxy group.

Another embodiment of the present invention is an electrode including a particle containing silicon and a graphene compound having a vacancy. At least part of the surface of the particle is terminated by a functional group containing oxygen, the graphene compound contains a plurality of carbon atoms and one or more hydrogen atoms, each of the one or more hydrogen atoms terminates any of the plurality of carbon atoms, and the vacancy is formed with the plurality of carbon atoms and the one or more hydrogen atoms.

In the above description, the functional group is preferably a hydroxy group, an epoxy group, or a carboxy group.

Another embodiment of the present invention is a secondary battery including the electrode described in any one of the above structures and an electrolyte.

Another embodiment of the present invention is a moving vehicle including the secondary battery described in any one of the above structures.

### Effect of the Invention

According to an embodiment of the present invention, an electrode with excellent characteristics can be provided. According to another embodiment of the present invention, an active material with excellent characteristics can be provided. According to another embodiment of the present invention, a novel silicon material can be provided. According to another embodiment of the present invention, a novel electrode can be provided.

According to another embodiment of the present invention, a durable negative electrode can be provided. According to another embodiment of the present invention, a durable positive electrode can be provided. According to another embodiment of the present invention, a negative electrode with little deterioration can be provided. According to another embodiment of the present invention, a positive electrode with high capacity can be provided.

According to another embodiment of the present invention, a secondary battery with less deterioration can be provided. According to another embodiment of the present invention, a highly safe secondary battery can be provided. According to another embodiment of the present invention, a secondary battery with high energy density can be provided. According to another embodiment of the present invention, a novel secondary battery can be provided.

According to another embodiment of the present invention, a novel material, novel active material particles, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A and FIG. 1B are diagrams illustrating an example of a cross-section of an electrode.

FIG. 2A and FIG. 2B each illustrate an example of a model containing silicon.

FIG. 3 illustrates examples of a model containing silicon and a model of a graphene compound.

FIG. 4A and FIG. 4B each illustrate examples of a model containing silicon and a model of a graphene compound.

FIG. 5A and FIG. 5B each illustrate examples of a model containing silicon and a model of a graphene compound.

FIG. 6A and FIG. 6B each illustrate an example of a model of a graphene compound.

FIG. 7A and FIG. 7B illustrate examples of a model containing silicon and a model of a graphene compound.

FIG. 8A and FIG. 8B illustrate examples of a model containing silicon and a model of a graphene compound.

FIG. 9A and FIG. 9B each illustrate examples of a model containing silicon and a model of a graphene compound.

FIG. 10 illustrates an example of a method for manufacturing an electrode of one embodiment of the present invention.

FIG. 11 is a diagram explaining crystal structures of a positive electrode active material.

FIG. 12 is a diagram explaining crystal structures of a positive electrode active material.

FIG. 13 is a diagram illustrating an example of a cross section of a secondary battery.

FIG. 14A is an exploded perspective view of a coin-type secondary battery, FIG. 14B is a perspective view of the coin-type secondary battery, and FIG. 14C is a cross-sectional perspective view thereof.

FIG. 15A and FIG. 15B are examples of a cylindrical secondary battery, FIG. 15C is an example of a plurality of cylindrical secondary batteries, and FIG. 15D is an example of a power storage system including a plurality of cylindrical secondary batteries.

FIG. 16A and FIG. 16B are diagrams explaining examples of a secondary battery, and FIG. 16C is a diagram illustrating the internal state of the secondary battery.

FIG. 17A, FIG. 17B, and FIG. 17C are diagrams explaining an example of a secondary battery.

FIG. 18A and FIG. 18B are each an external view of a secondary battery.

FIG. 19A, FIG. 19B, and FIG. 19C are diagrams illustrating a method for manufacturing a secondary battery.

FIG. 20A is a perspective view illustrating a battery pack, FIG. 20B is a block diagram of the battery pack, and FIG. 20C is a block diagram of a vehicle having a motor.

FIG. 21A to FIG. 21D are diagrams explaining examples of moving vehicles.

FIG. 22A and FIG. 22B are diagrams explaining a power storage.

FIG. 23A to FIG. 23D are diagrams explaining examples of electronic devices.

FIG. 24 shows ToF-SIMS results.

FIG. 25A and FIG. 25B are surface SEM observation images.

FIG. 26A and FIG. 26B are cross-sectional SEM observation images.

FIG. 27 shows results of cycle performance.

FIG. 28A and FIG. 28B are surface SEM observation images.

FIG. 29A to FIG. 29E show EELS analysis results.

FIG. 30A to FIG. 30E show EELS analysis results.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

### Embodiment 1

In this embodiment, an electrode, an active material, a conductive agent, and the like of one embodiment of the present invention are described.

### <Example of Electrode>

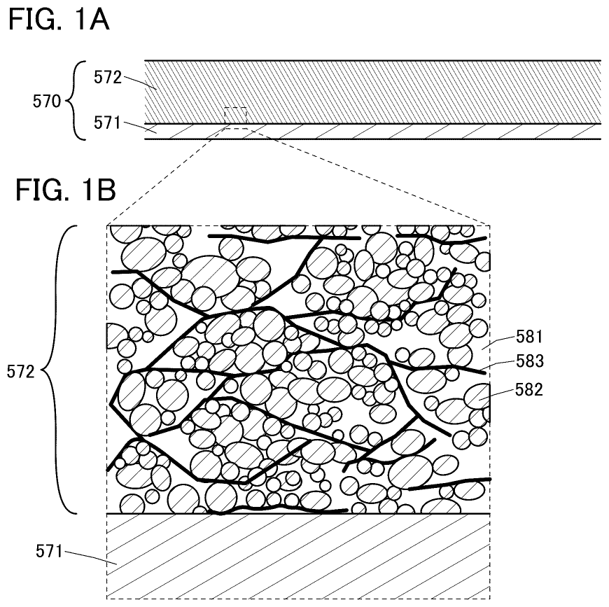

FIG. 1A is a cross-sectional schematic view illustrating an electrode of one embodiment of the present invention. An electrode 570 illustrated in FIG. 1A can be applied to a positive electrode and a negative electrode of a secondary battery. The electrode 570 includes at least a current collector 571 and an active material layer 572 formed in contact with the current collector 571.

FIG. 1B is an enlarged view of a region surrounded by a dashed line in FIG. 1A. As illustrated in FIG. 1B, the active material layer 572 includes an electrolyte 581 and a particle 582. The particle 582 preferably functions as an active material. A material functioning as an active material can be used as the particle 582. The particle 582 preferably includes a material serving as an active material, for example. A material having a sheet-like shape included in the electrode 570 preferably functions as a conductive agent, for example. In one embodiment of the present invention, the conductive agent can cling to the active material due to a hydrogen bond, whereby an electrode with high conductivity can be provided. As the particle 582, various materials can be used. Materials that can be used as the particle 582 will be described later.

The active material layer 572 preferably contains a carbon-based material such as graphene compound, carbon black, graphite, carbon fiber, or fullerene, especially a graphene compound is preferably contained. As the carbon black, acetylene black (AB) can be used, for example. As the graphite, natural graphite or artificial graphite such as mesocarbon microbeads can be used, for example. These carbon-based materials have high conductivity and can function as a conductive agent in the active material layer. These carbon-based materials may each function as an active material. FIG. 1B shows an example in which the active material layer 572 contains a graphene compound 583. In the active material layer 572, the graphene compound preferably clings to the particle 582 and one or more selected from carbon black, graphite, carbon fiber, and fullerene.

In the active material 572, the graphene compound may cling to the particle 582 or the like with a binder therebetween. For example, the graphene compound includes a region in contact with the binder, and the binder includes a region in contact with the particle 582. In such a case, the graphene compound may include both the region in contact with the binder and the region in contact with the particle 482. The graphene compound may be placed so as to cover the binder attached to the particle 582.

Examples of carbon fiber include mesophase pitch-based carbon fiber and isotropic pitch-based carbon fiber. Other examples of carbon fiber include carbon nanofiber and carbon nanotube. Carbon nanotube can be formed by, for example, a vapor deposition method.

The active material layer may contain as a conductive agent one or more selected from metal powder and metal fiber of copper, nickel, aluminum, silver, gold, or the like, a conductive ceramic material, and the like.

The content of the conductive additive to the total amount of the active material layer is preferably greater than or equal to 1 wt % and less than or equal to 10 wt %, and further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Thus, discharge capacity of the secondary battery can be increased.

Furthermore, the graphene compound of one embodiment of the present invention has excellent permeability to lithium; therefore, the charging and discharging rate of the secondary battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. When the secondary battery includes the electrolyte of one embodiment of the present invention, the secondary battery can be operated more stably. That is, the secondary battery of one embodiment of the present invention can have both high energy density and stability, and is useful as an in-vehicle secondary battery. When a vehicle becomes heavier with increasing number of secondary batteries, more energy is required to move the vehicle, which shortens the driving range. With the use of a high-density secondary battery, the driving range of the vehicle can be increased with almost no change in the total weight of a vehicle equipped with a secondary battery having the same weight.

Furthermore, an in-vehicle secondary battery with high capacity requires more power for charging, so that charging is preferably ended in a short time. What is called a regenerative charging, in which electric power temporarily generated when the vehicle is braked is used for charging, is performed under high rate charging conditions; thus, a secondary battery for a vehicle is desired to have favorable rate characteristics.

In the active material layer 572 in FIG. 1B, a plurality of graphene compounds 583 are arranged in a three-dimensional net-like shape and the particles 582 are provided between the plurality of graphene compounds 583.

With the use of an electrolyte of one embodiment of the present invention, an in-vehicle secondary battery having a wide operation temperature range can be obtained.

In addition, the secondary battery of one embodiment of the present invention can be downsized owing to its high energy density, and can be charged fast owing to its high conductivity. Thus, the structure of the secondary battery of one embodiment of the present invention is useful also in a portable information terminal.

The active material layer 572 preferably includes a binder (not illustrated). The binder binds or fixes the electrolyte and the active material, for example. In addition, the binder can bind or fix the electrolyte and a carbon-based material, the active material and a carbon-based material, a plurality of active materials, a plurality of carbon-based materials, or the like.

As the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Polyimide has thermally, mechanically, and chemically excellent stable properties. In the case of using polyimide as a binder, a dehydration reaction and cyclization (imidizing) are performed. These reactions can be performed by heat treatment, for example. In an electrode of one embodiment of the present invention, when graphene having a functional group containing oxygen and polyimide are used as the graphene compound and the binder, respectively, the graphene compound can also be reduced by the heat treatment, leading to simplification of the process. Because of high heat-resistance, heat treatment can be performed at a heat temperature of 200° C. or higher. The heat treatment at a heat temperature of 200° C. or higher allows the graphene compound to be reduced sufficiently and the conductivity of the electrode to increase.

For example, a fluorine polymer which is a high molecular material containing fluorine, specifically, polyvinylidene fluoride (PVDF) can be used. PVDF is a resin having a melting point in the range of higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used. Alternatively, fluororubber can be used as the binder.

As the binder, for example, water-soluble polymers are preferably used. As the water-soluble polymers, a polysaccharide can be used, for example. As the polysaccharide, one or more selected from starch, a cellulose derivative such as carboxymethyl cellulose (CMC), methyl cellulose, ethyl cellulose, hydroxypropyl cellulose, diacetyl cellulose, and regenerated cellulose, and the like can be used. It is further preferred that such water-soluble polymers be used in combination with any of the above rubber materials.

Two or more of the above materials may be used in combination for the binder.

The graphene compound 583 is flexible and has a flexibility, and can cling to the particle 582, like natto (fermented soybeans). For example, the particle 582 and the graphene compound 583 can be likened to a soybean and a sticky ingredient, e.g., polyglutamic acid, respectively. By providing the graphene compound 583 as a bridge between materials included in the active material layer 572, such as the electrolyte, the plurality of active materials, and the plurality of carbon-based materials, it is possible to not only form an excellent conductive path in the active material layer 572 but also bind or fix the materials with use of the graphene compound 583. In addition, for example, a three-dimensional net-like structure or an arrangement structure of polygons, e.g., a honeycomb structure in which hexagons are arranged in matrix, is formed using the plurality of graphene compounds 583 and materials such as the electrolyte, the plurality of active materials, and the plurality of carbon-based materials are placed in meshes, whereby the graphene compounds 583 form a three-dimensional conductive path and detachment of an electrolyte from the current collector can be suppressed. In the arrangement structure of polygons, polygons with different number of sides may be intermingled. Thus, in the active material layer 572, the graphene compound 583 functions as a conductive agent and may also function as a binder.

The particle 582 can have any of various shapes such as a rounded shape and an angular shape. In addition, on the cross section of the electrode, the particle 582 can have any of various cross-sectional shapes such as a circle, an ellipse, a shape having a curved line, and a polygon. For example, FIG. 1B illustrates an example in which the cross section of the particle 582 has a rounded shape as an example; however, the cross section of the particle 582 may be angular, for example. Alternatively, one part may be rounded and another part may be angular.

### <Graphene Compound>

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring of carbon. The two-dimensional structure formed of the six-membered ring of carbon may be referred to as a carbon sheet. A graphene compound may include a functional group. The graphene compound is preferably bent. A graphene compound may be rounded like a carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring of carbon, for example. The reduced graphene oxide may also be referred to as a carbon sheet. Only one sheet of the reduced graphene oxide can function but may have a stacked structure of multiple sheets. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

Reducing graphene oxide can form a vacancy in a graphene compound in some cases.

Furthermore, a material in which an end portion of graphene is terminated by fluorine may be used.

In the longitudinal cross section of the active material layer, the sheet-like graphene compounds are preferably dispersed substantially uniformly in a region inside the active material layer. The plurality of graphene compounds are formed to partly cover the plurality of particulate active materials or adhere to the surfaces thereof, so that the graphene compounds make surface contact with the particulate active materials.

Here, the plurality of graphene compounds can be bonded to each other to form a net-like graphene compound sheet (hereinafter, referred to as a graphene compound net or a graphene net). A graphene net that covers the active material can function also as a binder for bonding the active materials. Accordingly, the amount of the binder can be reduced, or the binder does not have to be used. This can increase the proportion of the active material in the electrode volume and the electrode weight. That is to say, the charge and discharge capacity of the secondary battery can be increased.

Here, preferably, graphene oxide is used as the graphene compound and mixed with an active material to form a layer to be the active material layer, and then reduction is performed. In other words, the formed active material layer preferably contains reduced graphene oxide. When a graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conduction path. Note that graphene oxide can be reduced by heat treatment or with the use of a reducing agent, for example.

It is possible to form, with a spray dry apparatus, a graphene compound serving as a conductive material as a coating film to cover the entire surface of the active material in advance and to electrically connect the active materials by the graphene compound to form a conduction path.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

A graphene compound of one embodiment of the present invention preferably includes a vacancy in part of a carbon sheet. In the graphene compound of one embodiment of the present invention, a vacancy through which carrier ions such as lithium ions can pass is provided in part of a carbon sheet, which can facilitate insertion and extraction of carrier ions in the surface of an active material covered with the graphene compound to increase the rate characteristics of a secondary battery. The vacancy provided in part of the carbon sheet is referred to as a hole, a defect, or a gap in some cases.

A graphene compound of one embodiment of the present invention preferably includes a vacancy formed with a plurality of carbon atoms and one or more fluorine atoms. Furthermore, the plurality of carbon atoms are preferably bonded to each other in a ring and one or more of the plurality of carbon atoms bonded to each other in a ring are preferably terminated by fluorine. Fluorine has high electronegativity and is easily negatively charged. Approach of positively-charged lithium ions causes interaction, whereby energy is stable and the barrier energy in passage of lithium ions through a vacancy can be lowered. Thus, fluorine contained in a vacancy in a graphene compound allows a lithium ion to easily pass through even a small vacancy; therefore, the graphene compound can have excellent conductivity.

For example, in the case where graphene has a vacancy, it is possible that a spectrum based on a feature caused by the vacancy is observed in Raman spectroscopic mapping measurement. Furthermore, it is possible that a bond, a functional group, and the like included in the vacancy are observed with ToF-SIMS. It is also possible that the vicinity, surrounding, and the like of the vacancy are observed in TEM observation.

### <Example of Negative Electrode Active Material>

In the case where the electrode 570 is a negative electrode, a particle containing a negative electrode active material can be used as the particle 582. As the negative electrode active material, a material that can react with carrier ions of the secondary battery, a material into and from which carrier ions can be inserted and extracted, a material that enables an alloying reaction with a metal serving as a carrier ion, a material that enables melting and precipitation of a metal serving as a carrier ion, or the like is preferably used.

An example of the negative electrode active material is described below.

Silicon can be used as the negative electrode active material. In the electrode 570, a particle containing silicon is preferably used as the particle 582.

In addition, a metal or a compound containing one or more elements selected from tin, gallium, aluminum, germanium, lead, antimony, bismuth, silver, zinc, cadmium, and indium, can be used as the negative electrode active material. Examples of an alloy-based compound using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Silicon whose resistance is lowered by addition of an impurity element such as phosphorus, arsenic, boron, aluminum, or gallium may be used as a material. A silicon material pre-doped with lithium may also be used. Examples of the pre-doping method include a method of mixing lithium fluoride, lithium carbonate, or the like with silicon and annealing the mixture and a method of mechanical alloying a lithium metal and silicon. An electrode is formed and then is doped with lithium by a charging and discharging reaction in combination with an electrode made of a lithium metal or the like, and then, the doped electrode and a counter electrode (for example, a positive electrode opposite to the pre-doped negative electrode) are used together to form a secondary battery.

For example, silicon nanoparticles can be used as the particle 582. The average diameter of a silicon nanoparticle is, for example, preferably greater than or equal to 5 nm and less than 1 μm, more preferably greater than or equal to 10 nm and less than or equal to 300 nm, still more preferably greater than or equal to 10 nm and less than or equal to 100 nm.

The silicon nanoparticles may have crystallinity. The silicon nanoparticles may include a region with crystallinity and an amorphous region.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous. A particle in which a graphene compound clings to a secondary particle of silicon may be used.

As a compound containing silicon, Li₂SiO₃ and Li₄SiO₄ can be used, for example. Each of Li₂SiO₃ and Li₄SiO₄ may have crystallinity, or may be amorphous.

The analysis of the compound containing silicon can be performed by nuclear magnetic resonance (NMR), X-ray diffraction (XRD), Raman spectroscopy, a scanning electron microscope (SEM), a transmission electron microscope (TEM), energy-dispersive X-ray spectroscopy (EDX), or the like.

Moreover, a carbon-based material such as graphite, graphitizing carbon, non-graphitizing carbon, a carbon nanotube, carbon black, or a graphene compound can be used as the negative electrode active material, for example.

Furthermore, an oxide containing one or more elements selected from titanium, niobium, tungsten, and molybdenum can be used as the negative electrode active material, for example.

Two or more of such metals, materials, compounds, and the like described above can be used in combination for the negative electrode active material.

Alternatively, for the negative electrode active material, an oxide such as SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used, for example.

In addition, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g).

The composite nitride of lithium and a transition metal is preferably used as a negative electrode material, in which case the negative electrode material can combined with a material not containing lithium ions, such as V₂O₅ or Cr₃O₈ as a positive electrode material. Note that even in the case of using a material containing lithium ions as a positive electrode material, the composite nitride of lithium and a transition metal can be used as the negative electrode material by extracting lithium ions contained in the positive electrode material in advance.

Alternatively, a material that causes a conversion reaction can be used as the negative electrode active material. For example, a transition metal oxide that does not cause an alloying reaction with lithium, such as cobalt oxide (CoO), nickel oxide (NiO), and iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides may be used as a positive electrode material because of its high potential.

The volume of the particle 582 sometimes changes in charging and discharging; however, an electrolyte containing fluorine placed between a plurality of particles 582 in an electrode maintains smoothness and suppresses a crack even when the volume changes in charging and discharging, so that an effect of dramatically increasing cycle performance is obtained. It is important that an organic compound containing fluorine exists between a plurality of active materials included in the electrode.

### <Calculation>

The interaction between a particle containing silicon and a graphene compound is optimized and evaluated by density functional theory (DFT). The calculation of optimization is calculated using Gaussian 09. The main conditions of calculation are listed in Table 1.

TABLE 1

| Calculation program | Gaussian 09 |
|---|---|
| Functional | ωB97XD |
| Basis function | 6-31G** |
| Charge | 0 |
| Spin multiplicity | 1 |

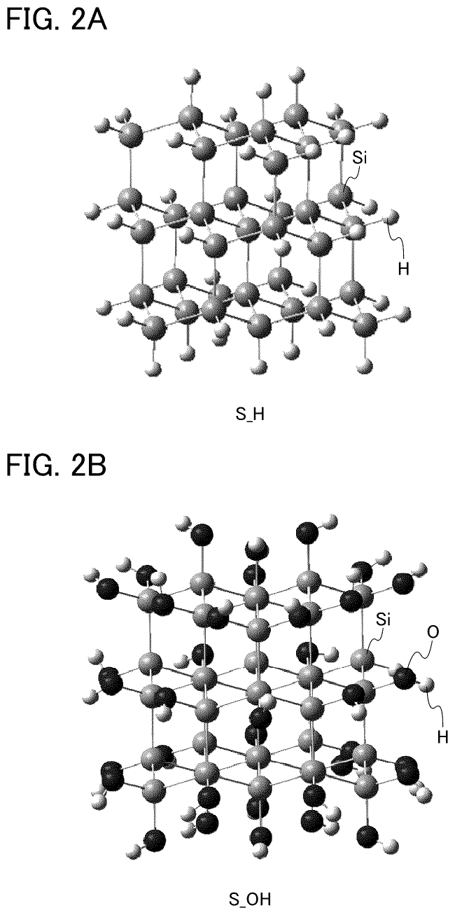

As the particle containing silicon, two kinds of Models, hydrogen-terminated silicon (Model S_H) and hydroxy group-terminated silicon (Model S_OH), are used. A structure composed of 35 silicon atoms and 35 hydrogen atoms illustrated in FIG. 2A is used as the Model S_H. A structure composed of 35 silicon atoms, 35 oxygen atoms, and 35 hydrogen atoms illustrated in FIG. 2B is used as the Model S_OH.

As graphene (Model G-1), a structure composed of 170 carbon atoms and 36 hydrogen atoms is used. All of the 36 hydrogen atoms terminate the end portions of the graphene.

Five models are used as graphene compounds, including graphene containing one carbon atom bonded to an epoxy group (Model G-2), graphene containing two carbon atoms bonded to hydroxy groups (Model G-3), graphene containing two hydrogen-terminated carbon atoms (Model G-4), and graphene containing two fluorine-terminated carbon atoms (Model G-5). In each model, carbon terminated by a functional group or an atom is placed near the center.

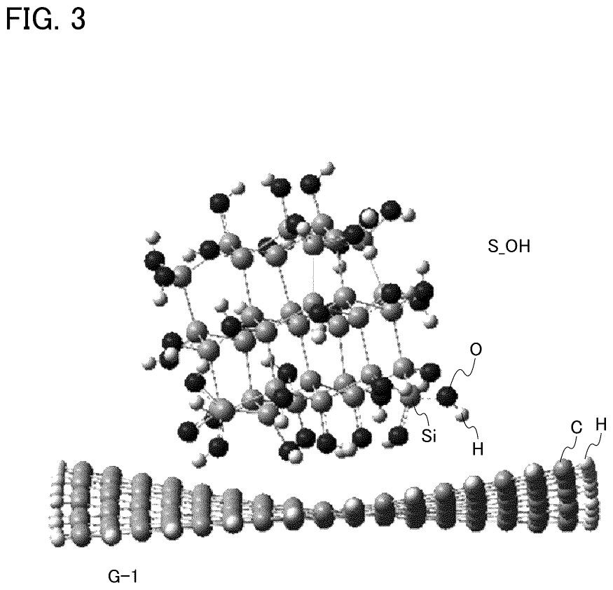

FIG. 3 illustrates an example of an interaction between the particle containing silicon and the graphene compound after the optimization. It is shown that the particle containing silicon comes close to the graphene compound in distance by the optimization. It is also shown that the graphene compound is curved. The curve of the graphene compound is considered to result from London dispersion force. Note that the state where the hydroxy group-terminated silicon (Model S_OH) and graphene (Model G-1) are close to each other is illustrated in FIG. 3.

Stabilization energy of each combination is calculated to evaluate the interaction between the particle containing silicon and the graphene compound. The results are shown in Table 2. The energy in the case where the particle containing silicon and the graphene compound are arranged at infinity is a reference, and an absolute value of the difference from the reference is regarded as stabilization energy. Higher value of the stabilization energy in Table 2 and Table 3 show higher stability.

TABLE 2
[eV]

| | | |
|---|---|---|
| S_OH | G-1 | 1.52 |
| | G-2 (—O—) | 1.74 |
| | G-3 (—OH) | 1.66 |
| | G-4 (—H) | 1.62 |
| | G-5 (—F) | 1.76 |
| S_H | G-1 | 1.38 |
| | G-4 (—H ) | 1.33 |

As shown in Table 2, the stabilization energy of the silicon terminated by a hydroxy group (Model S_OH) is higher than that of the hydrogen-terminated silicon (Model S_H). Moreover, the stabilization energy of each of the graphene compounds containing carbon bonded to a functional group, a hydrogen atom, or a fluorine atom in graphene plane (Models G-2 to G-5) is higher than that of graphene (Model G-1).

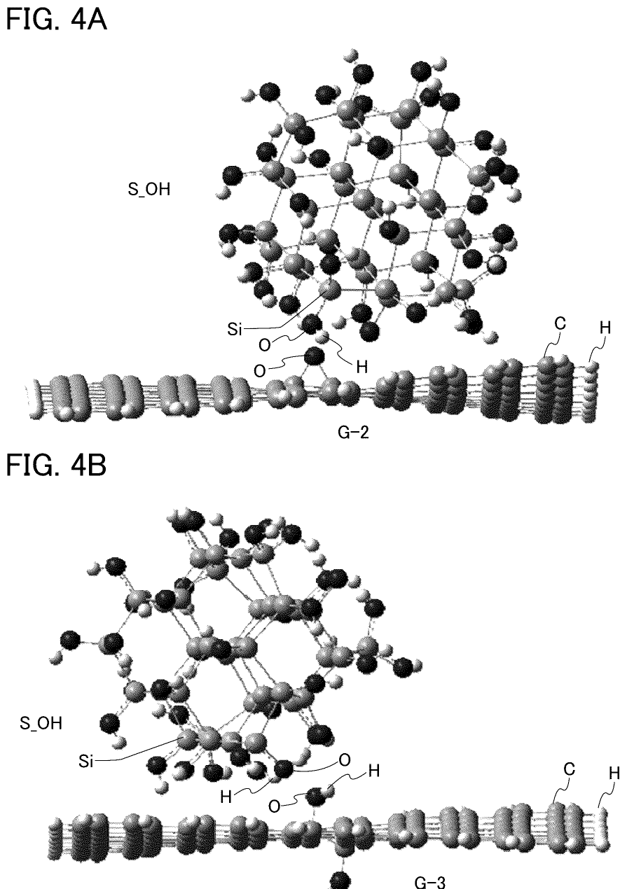

FIG. 4A illustrates a state where silicon with a hydroxy group (Model S_OH) is brought close to the graphene containing carbon bonded to an epoxy group (Model G-2). This suggests that a hydrogen bond is formed between oxygen contained in the epoxy group and a hydroxy group in the silicon surface.

FIG. 4B illustrates a state where silicon terminated by a hydroxy group (Model S_OH) is brought close to the graphene containing carbon bonded to a hydroxy group (Model G-3). This suggests that a hydrogen bond is formed between the hydroxy groups of the both.

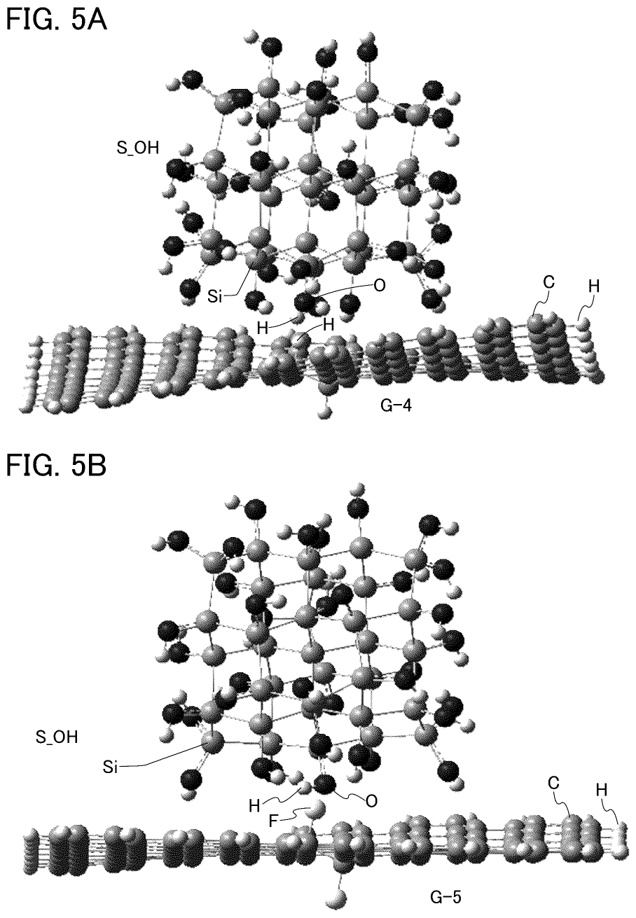

FIG. 5A illustrates a state where the silicon terminated by a hydroxy group (Model S_OH) is brought close to the graphene containing carbon terminated by a hydrogen atom (Model G-4). This suggests that a hydrogen bond is formed between the hydrogen atom contained in graphene and the hydroxy group in the silicon surface.

FIG. 5B illustrates a state where the silicon terminated by a hydroxy group (Model S_OH) is brought close to the graphene containing carbon terminated by a fluorine atom (Model G-5). This suggests that a hydrogen bond is formed between the fluorine atom contained in graphene and the hydroxy group in the silicon surface.

The silicon surface is terminated by a hydroxy group, so that the hydrogen bond with the graphene compound is probably formed, increasing the stabilization energy.

Next, a model of graphene having a vacancy is examined.

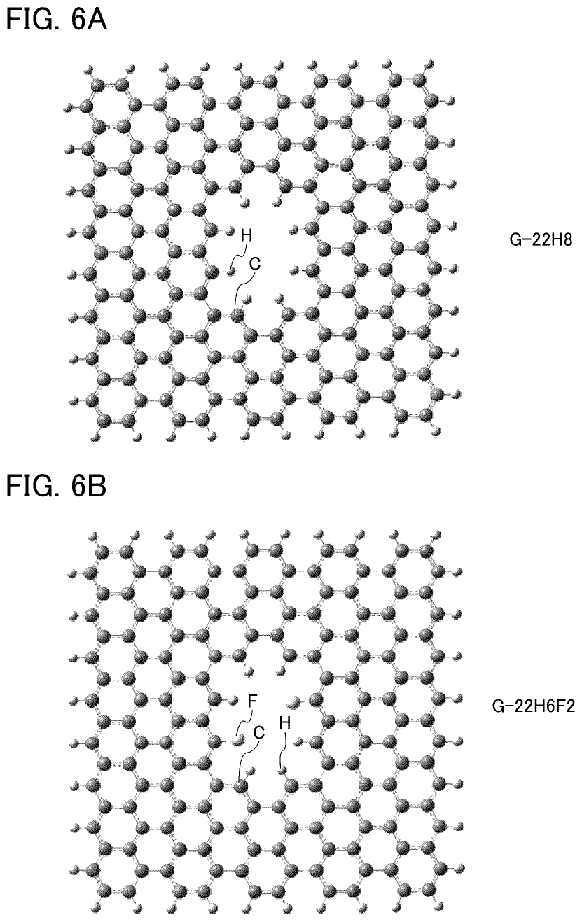

FIG. 6A and FIG. 6B each illustrate an example of a structure of a graphene compound having a vacancy.

A structure illustrated in FIG. 6A (hereinafter, Model G-22H8) has a 22-membered ring, and eight carbon atoms contained in the 22-membered ring are each terminated by hydrogen. Model G-22H8 has a structure in which two six-membered rings that are connected to each other are removed from graphene and carbon bonded to the removed six-membered rings is terminated by hydrogen.

The structure illustrated in FIG. 6B (hereinafter referred to as Model G-22H6F2) has a 22-membered ring, and six carbon atoms of eight carbon atoms contained in the 22-membered ring are terminated by hydrogen, and two carbon atoms thereof are terminated by fluorine. Model G-22H6F2 has a structure in which two six-membered rings that are connected to each other are removed from graphene and carbon bonded to the removed six-membered rings is terminated by hydrogen or fluorine.

Stabilization energy of each combination of the particle containing silicon and the graphene compound having a vacancy is calculated. The results are shown in Table 3.

TABLE 3
[eV]

| | | |
|---|---|---|
| S_OH | G-22H8 | 1.94 |
| | G-22H6F2 | 2.05 |
| S_H | G-22H8 | 1.33 |
| | G-22H6F2 | 1.35 |

As shown in Table 3, it is suggested that the silicon terminated by a hydroxy group (Model S_OH) has a high stabilization energy and a large interaction with the graphene compound having a vacancy.

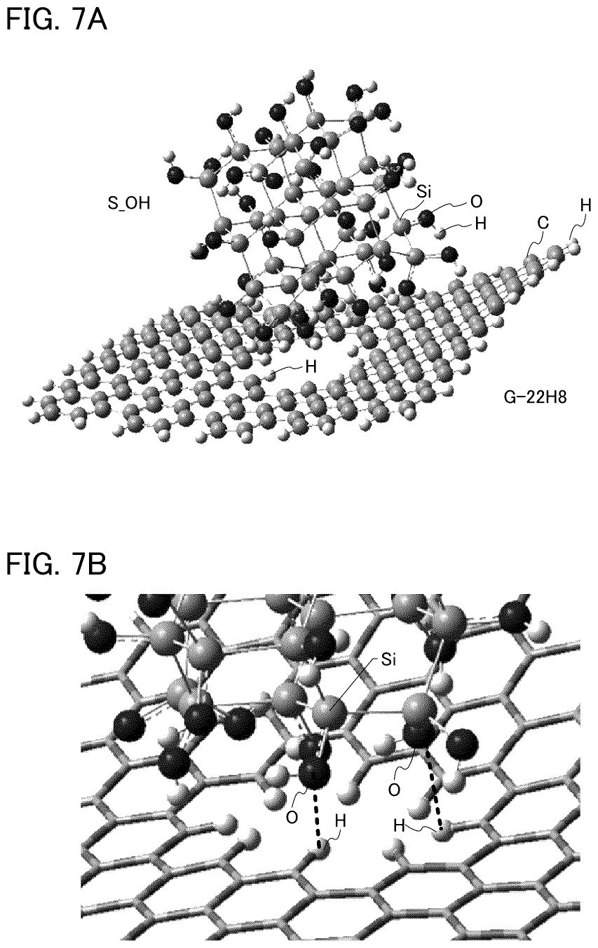

FIG. 7A illustrates a state where the silicon terminated by a hydroxy group (Model S_OH) and Model G-22H8 are brought closer together. FIG. 7B is an enlarged view including a region where the silicon terminated by a hydroxy group (Model S_OH) and Model G-22H8 are brought closer together. As shown by the dashed lines in FIG. 7B, it is suggested that a hydrogen bond is formed between a hydrogen atom contained in the graphene and a hydroxy group in the silicon surface.

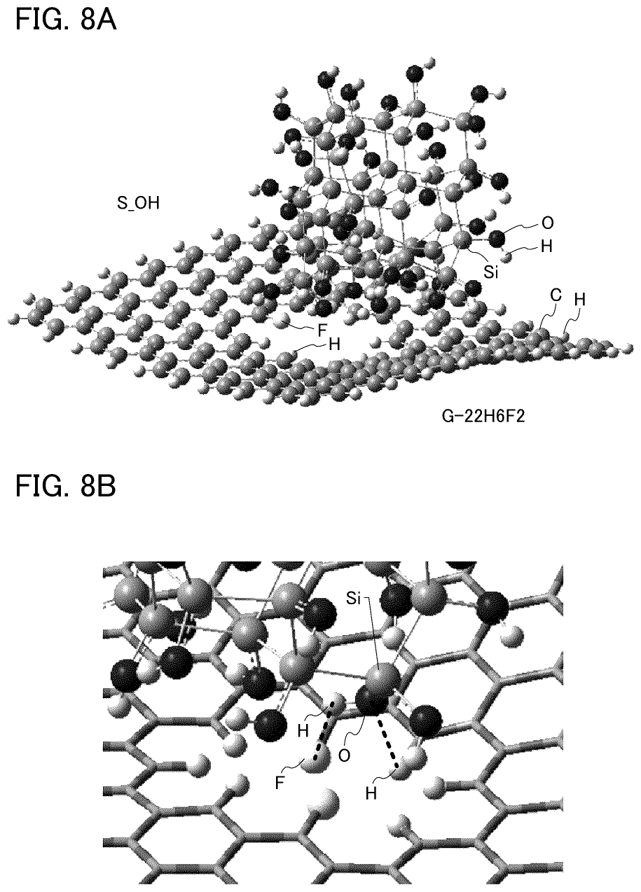

FIG. 8A illustrates a state where the hydroxy group-terminated silicon (Model S_OH) and Model G-22H6F2 are brought closer together. FIG. 8B is an enlarged view including a region where the hydroxy group-terminated silicon (Model S_OH) and Model G-22H6F2 are brought closer together. As shown by the dashed lines in FIG. 8B, it is suggested that a hydrogen bond is formed between a hydrogen atom contained in the graphene and oxygen of the hydroxy group in the silicon surface. It is also suggested that a hydrogen bond is formed between a fluorine atom contained in the graphene and hydrogen contained in the hydroxy group in the silicon surface.

It is suggested that when the graphene compound contains fluorine as well as hydrogen, in addition to the hydrogen bond between an oxygen atom of the hydroxy group and a hydrogen atom of the graphene compound, the hydrogen bond between a hydrogen atom of the hydroxy group and a fluorine atom of the graphene compound is also formed, further strengthening the interaction between the particle containing silicon and the graphene compound and further increasing the stabilization energy.

On the other hand, as shown in Table 2, the hydrogen-terminated silicon (Model S_H) has a lower stabilization energy with each of two kinds of the graphene compounds having a vacancy shown in Table 2 than that of the hydroxy group-terminated silicon (Model S_OH).

It is considered that the silicon surface is terminated by a hydroxy group, and the graphene compound includes a vacancy terminated by hydrogen or fluorine, whereby a hydrogen bond is formed and the stabilization energy is increased.

Next, the interaction with the graphene compound in the case where the particle containing silicon is silicon oxide is calculated. As a model of the silicon oxide (hereinafter, Model S_Ox), a structure containing 20 silicon atoms, 28 hydrogen atoms, and 54 oxygen atoms is used. A dangling bond at the end is terminated by a hydroxy group.

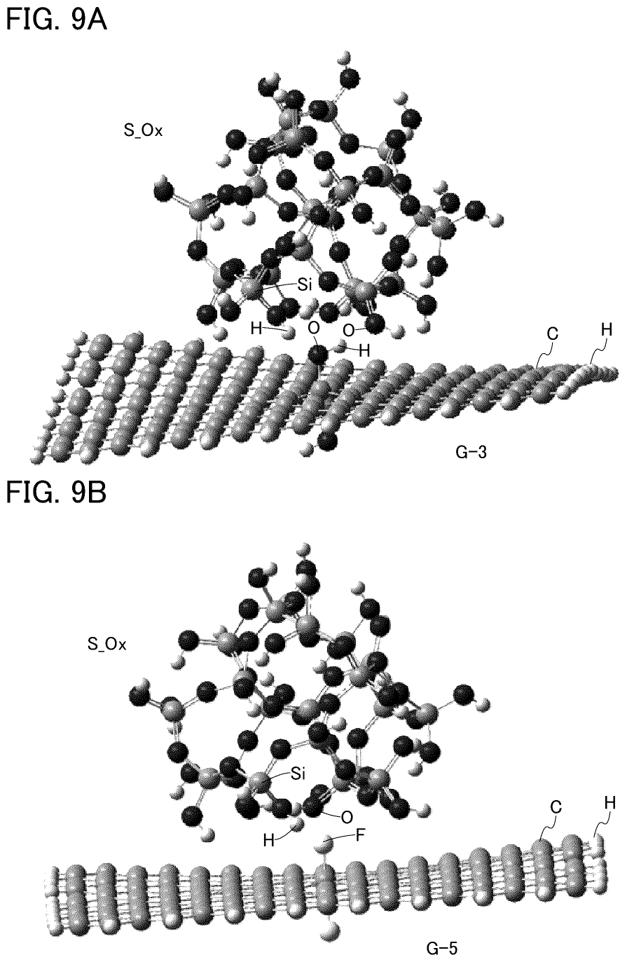

Table 4 shows the calculated results of the stabilization energy. FIG. 9A illustrates an optimization state of silicon oxide and the graphene containing carbon terminated by a hydroxy group (Model G-3), and FIG. 9B illustrates an optimization state of silicon oxide and the graphene containing carbon terminated by fluorine (Model G-5). It is suggested that also in the silicon oxide terminated by a hydroxy group, the bond is strengthened when the graphene compound includes a functional group or a vacancy.

TABLE 4
[eV]

| | | |
|---|---|---|
| S_Ox | G-1 | 1.71 |
| | G-2 (—O—) | 2.04 |
| | G-3 (—OH) | 2.14 |
| | G-4 (—H) | 1.75 |
| | G-5 (—F) | 2.15 |
| | G-22H8 | 1.88 |
| | G-22H6F2 | 1.97 |

### <Method for Forming Electrode>

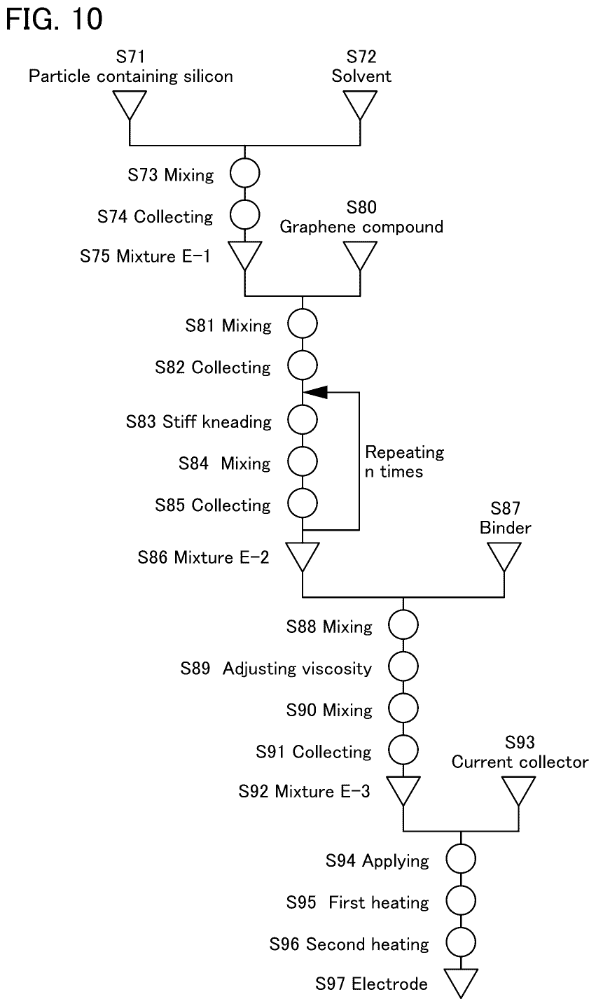

FIG. 10 is a flow chart showing an example of a method for forming an electrode of one embodiment of the present invention.

First, a particle containing silicon is prepared in Step S71. As the particle containing silicon, the particle given as the above-described particle 582 can be used.

In Step S72, a solvent is prepared. For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as the solvent.

Next, in Step S73, the particle containing silicon prepared in Step S71 and the solvent prepared in Step S72 are mixed, the mixture is collected in Step S74, and a mixture E-1 is obtained in Step S75. A kneader or the like can be used for the mixing. As the kneader, a planetary centrifugal mixer can be used, for example.

Next, a graphene compound is prepared in Step S80.

Next, in Step S81, the mixture E-1 and the graphene compound prepared in Step S80 are mixed and a mixture is collected in Step S82. The collected mixture preferably has a high viscosity. Because of the high viscosity, stiff kneading (kneading in high viscosity) can be performed in the following Step S83

Next, stiff kneading is performed in Step S83. The stiff kneading can be performed with use of a spatula for example. By performing the stiff kneading, a mixture with high dispersibility of the graphene compound, in which the particle containing silicon and the graphene compound are mixed well, can be formed.

Next, mixing of the stiff-kneaded mixture is performed in Step S84. The kneader or the like can be used for the mixing, for example. The mixture subjected to the mixing is collected in Step S85.

The steps of Step S83 to Step 85 are preferably repeated n times on the mixture collected in Step S85. For example, n is a natural number of greater than or equal to 2 and less than or equal to 10. In the step of Step S83, when the mixture is dried, a solvent is preferably added thereto. In addition, for example, while the steps are repeated n times, a solvent may be added in Step S83 in some cases and a solvent may not be added in Step S83 in other cases. However, when a solvent is added too much, the viscosity is lowered and the effect of stiff-kneading is decreased.

Step S83 to Step S85 are repeated n times, and then a mixture E-2 is obtained (Step S86).

Next, a binder is prepared in Step S87. As the binder, any of the above-described materials can be used, and especially polyimide is preferred. Note that in Step S87, a precursor of a material used as the binder is prepared in some cases. For example, a precursor of polyimide is prepared.

Next, in Step S88, the mixture E-2 is mixed with the binder prepared in Step S87. Next, in Step S89, the viscosity is adjusted. Specifically, for example, a solvent of the same kind as the solvent prepared in Step S72 is prepared and is added to the mixture obtained in Step S88. By adjusting the viscosity, for example, the thickness, density, and the like of the electrode obtained in Step S97 can be adjusted in some cases.

Next, the mixture whose viscosity is adjusted in Step S89 is mixed in Step S90 and collected in Step S91, whereby a mixture E-3 is obtained (Step S92). The mixture E-3 obtained in Step S92 is referred to as a slurry, for example.

Next, a current collector is prepared in Step S93.

In Step S94, the mixture E-3 is applied onto the current collector prepared in Step S93. For the application, a slot die method, a gravure method, a blade method, or combination of any of the methods can be used, for example. Furthermore, a continuous coater or the like may be used for the application.

Next, first heating is performed in Step S95. By the first heating, the solvent is volatilized. The first heating is preferably performed at a temperature in the range from 50° C. to 200° C. inclusive, further preferably from 60° C. to 150° C. inclusive.

Heat treatment may be performed using a hot plate at 30° C. or higher and 70° C. or lower in an air atmosphere for 10 minutes or longer, and then, for example, heat treatment may be performed at room temperature or higher and 100° C. or lower in a reduced-pressure environment for 1 hour to 10 hours inclusive.

Alternatively, heat treatment may be performed using a drying furnace or the like. In the case of using a drying furnace, for example, heat treatment at 30° C. or higher and 120° C. or lower for 30 seconds to 2 hours inclusive may be performed.

In addition, the temperature may be increased stepwise. For example, after heat treatment is performed at 60° C. or lower for 10 minutes or shorter, heat treatment may further be performed at 65° C. or higher for 1 minute or longer.

Next, second heating is performed in Step S96. When polyimide is used as a binder, a cycloaddition reaction of polyimide is preferably generated by the second heating. In addition, a dehydration reaction of polyimide may be caused by the second heating in some cases. Alternatively, the dehydration reaction may be caused by the first heating in some cases. In the first heating, a cycloaddition reaction of polyimide may be caused. Moreover, a reduction reaction of the graphene compound is preferably caused by the second heating.

In Step S97, an electrode provided with an active material layer over the current collector is obtained.

The thickness of the active material layer formed in this manner is preferably greater than or equal to 5 μm and less than or equal to 300 μm, further preferably greater than or equal to 10 μm and less than or equal to 150 μm, for example. The amount of the active material carried in the active material layer may be greater than or equal to 2 mg/cm² and less than or equal to 50 mg/cm², for example.

The active material layer may be formed on both surfaces of the current collector or on only one surface of the current collector. Alternatively, there may be regions of both surfaces where the active material layer is partly formed.

After the solvent is volatilized from the active material layer, pressing is preferably performed by a compression method such as a roll press method or a flat plate press method. In the pressing, heat may be applied.

### <Example of Positive Electrode Active Material>

As the positive electrode active material, a composite oxide with a layered rock-salt crystal structure or a spinel crystal structure can be given, for example. As an example of the positive electrode active material, a compound having an olivine crystal structure can be given. As an example of the positive electrode active material, compounds such as LiFePO₄, LiFeO₂, LiNiO₂, LiMn₂O₄, V₂O₅, Cr₂O₅, and MnO₂ are given.

As a positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the positive electrode active material, lithium-manganese composite oxide represented by a composition formula LiₐMn_{b}M_{c}O_{d} can be used. Here, the element M is preferably silicon, phosphorus, or a metal element other than lithium and manganese, further preferably nickel. In the case where the whole particle of a lithium-manganese composite oxide is measured, it is preferable to satisfy the following at the time of discharging: 0<a/(b+c)<2; c>0; and 0.26≤(b+c)/d<0.5. Note that the proportions of metals, silicon, phosphorus, and other elements in the whole particle of a lithium-manganese composite oxide can be measured with, for example, an ICP-MS (inductively coupled plasma mass spectrometer). The proportion of oxygen in the whole particle of a lithium-manganese composite oxide can be measured by, for example, EDX (energy dispersive X-ray spectroscopy). Alternatively, the proportion of oxygen can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. The metal M contains a metal Me1. The metal Me1 is one or more kinds of metals including cobalt. The metal M can further contain a metal X in addition to the metal Me1. The metal X is one or more metals selected from magnesium, calcium, zirconium, lanthanum, barium, copper, potassium, sodium, and zinc.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with a deep depth, for example, at high charge voltage, is performed on LiNiO₂, the crystal structure might be broken because of the distortion. It is suggested that the influence of the Jahn-Teller effect is small for LiCoO₂ and the crystal structure is unlikely to be broken in charging and discharging with a deep depth and charging and discharging cycle performance is more excellent in some cases, which are preferable.

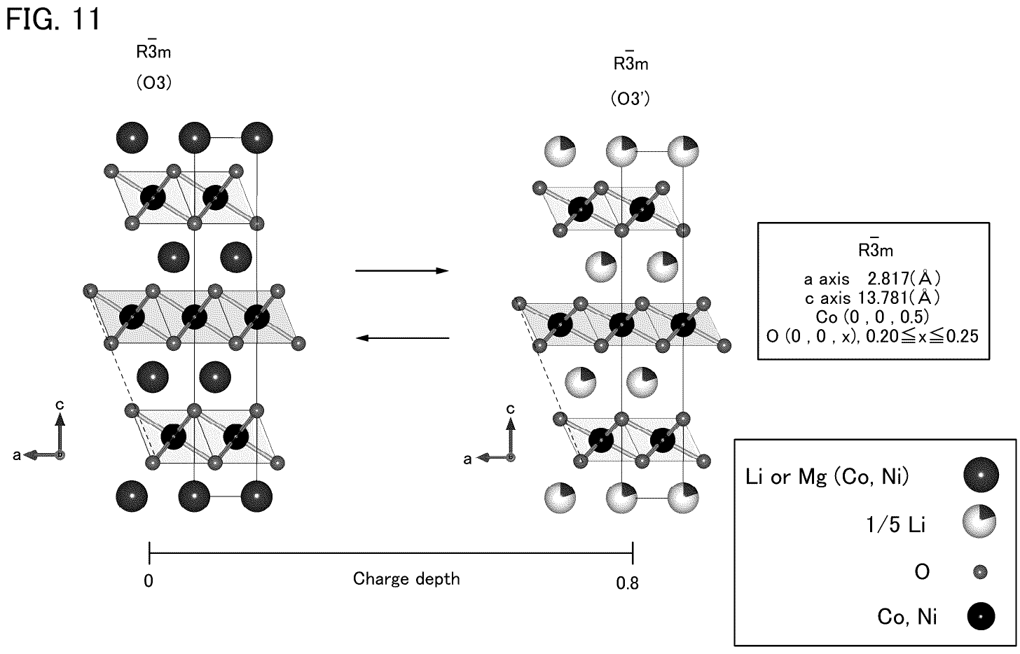

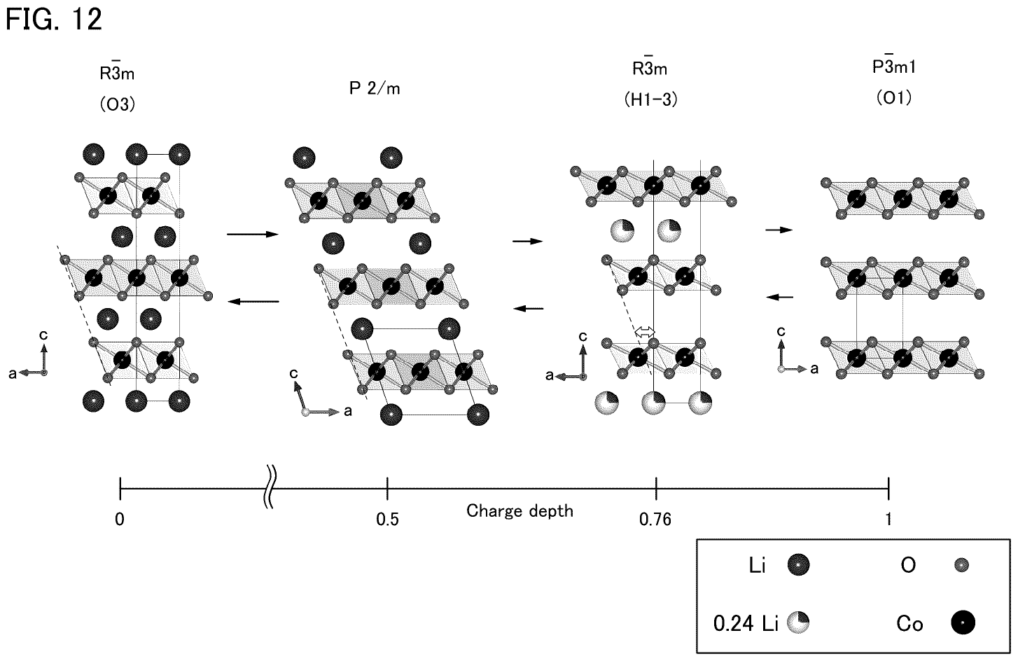

The positive electrode active material is described with reference to FIG. 11 and FIG. 12.

In the positive electrode active material formed according to one embodiment of the present invention, a deviation in the CoO₂ layers can be small in repeated charging and discharging at a deep depth. Furthermore, the change in the volume can be small. Thus, the compound can have excellent cycle performance. In addition, the compound can have a stable crystal structure in the state of a deep charge depth. Thus, in the compound, a short circuit is less likely to occur while the state of a deep charge depth is maintained. This is preferable because the safety is further improved.

The compound has a small change in the crystal structure and a small difference in volume per the same number of transition metal atoms between a sufficiently discharged state and the state of a large charge depth.

The positive electrode active material is preferably represented by a layered rock-salt crystal structure, and the region is represented by the space R-3m. The positive electrode active material is a region containing lithium, the metal Me1, oxygen, and the metal X FIG. 11 illustrates examples of the crystal structures of the positive electrode active material before and after charging and discharging. The surface portion of the positive electrode active material may include a crystal containing titanium, magnesium, and oxygen and exhibiting a structure different from a layered rock-salt crystal structure in addition to or instead of the region exhibiting a layered rock-salt crystal structure described below with reference to FIG. 11 and the like. For example, the surface portion of the positive electrode active material may include a crystal containing titanium, magnesium, and oxygen and exhibiting a spinel structure.

The crystal structure with a charge depth of 0 (in the discharged state) in FIG. 11 is R-3m (O3) as in FIG. 12. Meanwhile, the positive electrode active material, illustrated in FIG. 11, with a charge depth in a sufficiently charged state includes a crystal whose structure is different from the H1-3 type crystal structure. This structure belongs to the space group R-3m, and is not a spinel crystal structure but a structure in which an ion of cobalt, magnesium, or the like occupies a site coordinated to six oxygen atoms and the cation arrangement has symmetry similar to that of the spinel structure. Furthermore, the symmetry of CoO₂ layers of this structure is the same as that in the O3 type structure. Accordingly, this structure is referred to as an O3′ type crystal structure or a pseudo-spinel crystal structure in this specification and the like. Note that although lithium exists in any of lithium sites at an approximately 20% probability in the diagram of the O3′ type crystal structure illustrated in FIG. 11, the structure is not limited thereto. Lithium may exist in only some certain lithium sites. In addition, in both the O3 type crystal structure and the O3′ type crystal structure, a slight amount of magnesium preferably exists between the CoO₂ layers, i.e., in lithium sites. In addition, a slight amount of halogen such as fluorine may exist in oxygen sites at random.

Note that in the O3′ type crystal structure, a light element such as lithium is sometimes coordinated to four oxygen atoms. Also in that case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure generally.

Anions of a layered rock-salt crystal and anions of a rock-salt crystal have a cubic close-packed structure (face-centered cubic lattice structure). Anions of an O3′ type crystal are also presumed to form a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

In the positive electrode active material illustrated in FIG. 11, a change in the crystal structure when the positive electrode active material is charged with high charge voltage and a large amount of lithium is extracted is inhibited as compared with a comparative example described later. As shown by dotted lines in FIG. 11, for example, CoO₂ layers hardly deviate in the crystal structures.

More specifically, the structure of the positive electrode active material illustrated in FIG. 11 is highly stable even when a charge voltage is high. For example, in FIG. 12, an H1-3 type crystal structure is formed at a voltage of approximately 4.6 V, which is a charge voltage causing a H1-3 crystal structure, with the potential of e.g., a lithium metal as the reference; however, the positive electrode active material of one embodiment of the present invention can maintain the crystal structure of R-3m (O3) even at the charging voltage of approximately 4.6 V. Even at higher charge voltages, e.g., a voltage of approximately 4.65 V to 4.7 V with the potential of a lithium metal as the reference, the positive electrode active material of one embodiment of the present invention can have a region of the O3′ type crystal structure. At a charge voltage increased to be higher than 4.7 V, an H1-3 type crystal may be finally observed in the positive electrode active material of one embodiment of the present invention. In addition, the positive electrode active material of one embodiment of the present invention can have the O3′ type crystal structure even at a lower charge voltage (e.g., a charge voltage of greater than or equal to 4.5 V and less than 4.6 V with the potential of a lithium metal as the reference). Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with the potential of a lithium metal as the reference. Thus, even in a secondary battery that includes graphite as a negative electrode active material and has a voltage of greater than or equal to 4.3 V and less than or equal to 4.5 V, for example, the positive electrode active material of one embodiment of the present invention can maintain the crystal structure of R-3m (O3) and moreover, includes a region that can have the O3′ type crystal structure at higher voltages, e.g., a voltage of the secondary battery greater than 4.5 V and less than or equal to 4.6 V. In addition, the positive electrode active material of one embodiment of the present invention can have the O3′ type crystal structure at lower charge voltages, e.g., at a voltage of the secondary battery of greater than or equal to 4.2 V and less than 4.3 V, in some cases.

Thus, in the positive electrode active material illustrated in FIG. 11, the crystal structure is less likely to be disordered even when charging and discharging are repeated at high voltage.

In addition, in the positive electrode active material of one embodiment of the present invention, a difference in the volume per unit cell between the O3 type crystal structure with a charge depth of 0 and the O3′ type crystal structure with a charge depth of 0.8 is less than or equal to 2.5%, specifically, less than or equal to 2.2%.

In the unit cell of the O3′ type crystal structure, the coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers in high-voltage charging. Thus, when magnesium exists between the CoO₂ layers, the O3′ type crystal structure is likely to be formed.

However, cation mixing occurs when the heat treatment temperature is excessively high; thus, magnesium is highly likely to enter cobalt sites. Magnesium in the cobalt sites is less effective in maintaining the R-3m structure in high-voltage charging in some cases. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium over a whole particle. The addition of the halogen compound depresses the melting point of lithium cobalt oxide. The decreased melting point makes it easier to distribute magnesium throughout the particle at a temperature at which the cation mixing is unlikely to occur. Furthermore, it is expected that the existence of the fluorine compound can improve corrosion resistance to hydrofluoric acid generated by decomposition of an electrolyte.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material formed according to one embodiment of the present invention is preferably 0.001 times or more and 0.1 times or less, further preferably more than 0.01 times and less than 0.04 times, still further preferably approximately 0.02 times as large as the number of cobalt atoms. The magnesium concentration described here may be a value obtained by element analysis on overall particles of the positive electrode active material using ICP-MS or the like, or may be a value based on the ratio of the raw materials mixed in the process of forming the positive electrode active material, for example.

The number of nickel atoms in the positive electrode active material is preferably 7.5% or lower, preferably 0.05% or higher and 4% or lower, further preferably 0.1% or higher and 2% or lower of the number of cobalt atoms. The nickel concentration described here may be a value obtained by element analysis on overall particles of the positive electrode active material using ICP-MS or the like, or may be based on the mixture value of the raw materials in the forming process of the positive electrode active material, for example.

### <Particle Diameter>

A too large particle diameter of the positive electrode active material causes problems such as difficulty in lithium diffusion and too much surface roughness of an active material layer in application to a current collector. By contrast, too small a particle diameter causes problems such as difficulty in loading of the active material layer at the time when the material is applied to the current collector and overreaction with the electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material has the O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described so far, the positive electrode active material has a feature of a small change in the crystal structure between the high-voltage charged state and the discharged state. A material where 50 wt % or more of the crystal structure largely changes between the high-voltage charged state and the discharged state is not preferable because the material cannot withstand the high-voltage charging and discharging. In addition, it should be noted that an objective crystal structure is not obtained in some cases only by addition of impurity elements. For example, in a high-voltage charged state, lithium cobalt oxide containing magnesium and fluorine has the O3′ type structure at 60 wt % or more in some cases, and has the H1-3 type structure at 50 wt % or more in other cases. Furthermore, at a predetermined voltage, the positive electrode active material has almost 100 wt % of the O3′ type crystal structure, and with an increase in the predetermined voltage, the H1-3 type crystal structure is generated in some cases. Thus, the crystal structure of the positive electrode active material is preferably analyzed by XRD or the like. The combination with XRD measurement or the like enables more detailed analysis.

Note that a positive electrode active material in the high-voltage charged state or the discharged state sometimes has a change in the crystal structure when exposed to air. For example, the O3′ type crystal structure is changed into the H1-3 type crystal structure in some cases. Thus, all samples are preferably handled in an inert atmosphere such as an atmosphere containing argon.

A positive electrode active material illustrated in FIG. 12 is lithium cobalt oxide (LiCoO₂) to which the metal X is not added. The crystal structure of the lithium cobalt oxide illustrated in FIG. 12 is changed depending on a charge depth.

As illustrated in FIG. 12, lithium cobalt oxide with a charge depth of 0 (the discharged state) includes a region having the crystal structure of the space group R-3m, and includes three CoO₂ layers in a unit cell. Thus, this crystal structure is referred to as an O3 type crystal structure in some cases. Note that, the CoO₂ layer has a structure in which an octahedral structure with cobalt coordinated to six oxygen atoms continues on a plane in an edge-sharing state.

Lithium cobalt oxide with a charge depth of 1 has the crystal structure belonging to the space group P-3m1 and includes one CoO₂ layer in a unit cell. Hence, this crystal structure is referred to as an O1 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 12, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell containing one cobalt and two oxygen. Meanwhile, the O3′ type crystal structure of one embodiment of the present invention is preferably represented by a unit cell containing one cobalt and one oxygen. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material can be selected such that the value of GOF (goodness of fit) is smaller in Rietveld analysis of XRD, for example.

When charge with a high voltage of 4.6 V or higher with reference to the redox potential of a lithium metal or charge with a large charge depth of 0.76 or more and discharge are repeated, a change of the crystal structure of lithium cobalt oxide between the H1-3 type crystal structure and the R-3m (O3) structure in a discharged state (i.e., a nonequilibrium phase change) occurs repeatedly

However, there is a large deviation in the position of the CoO₂ layer between these two crystal structures. As indicated by dotted lines and an arrow in FIG. 12, the CoO₂ layer in the H1-3 type crystal structure greatly shifts from that in the R-3m (O3) structure. Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3m1 (01), included in the H1-3 type crystal structure is highly likely to be unstable.

Thus, the repeated high-voltage charge and discharge breaks the crystal structure of lithium cobalt oxide. The break of the crystal structure degrades the cycle performance. This is probably because the break of the crystal structure reduces sites where lithium can stably exist and makes it difficult to insert and extract lithium.

### <Electrolyte>

In the case of using a liquid electrolyte for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio as the electrolyte, for example.

Alternatively, the use of one or more ionic liquids (room temperature molten salts) that are incombustible and hard to volatile as the solvent of the electrolyte can prevent a secondary battery from exploding or catching fire even when the secondary battery internally shorts out or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention may include as a carrier ion one or more selected from alkali metal ions such as a sodium ion and a potassium ion and alkaline earth metal ions such as a calcium ion, a strontium ion, a barium ion, a beryllium ion, and a magnesium ion.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂, or the like can be used, for example.

In addition, the electrolyte preferably contains fluorine. As the electrolyte containing fluorine, an electrolyte including one kind or two or more kinds of fluorinated cyclic carbonates and lithium ions can be used, for example. The fluorinated cyclic carbonate can improve the nonflammability of the electrolyte and improve the safety of the lithium-ion secondary battery.

As the fluorinated cyclic carbonate, an ethylene fluoride carbonate such as monofluoroethylene carbonate (fluoroethylene carbonate, FEC or F1EC), difluoroethylene carbonate (DFEC or F2EC), trifluoroethylene carbonate (F3EC), or tetrafluoroethylene carbonate (F4EC) can be used. Note that DFEC includes an isomer such as cis-4,5 or trans-4,5. For operation at low temperatures, it is important that a lithium ion is solvated by using one kind or two or more kinds of fluorinated cyclic carbonates as the electrolyte and is transported in the electrolyte included in the electrode in charging and discharging. When the fluorinated cyclic carbonate is not used as a small amount of additive but is allowed to contribute to transportation of a lithium ion in charging and discharging, operation can be performed at low temperatures. In the secondary battery, a cluster of approximately several to several tens of lithium ions moves.

The use of the fluorinated cyclic carbonate for the electrolyte can reduce desolvation energy that is necessary for the solvated lithium ion in the electrolyte of the electrode to enter an active material particle. The reduction in the desolvation energy facilitates insertion or extraction of a lithium ion into/from the active material even in a low-temperature range. Although a lithium ion sometimes moves remaining in the solvated state, a hopping phenomenon in which coordinated solvent molecules are interchanged occurs in some cases. When desolvation from a lithium ion becomes easy, movement owing to the hopping phenomenon is facilitated and the lithium ion may easily move. A decomposition product of the electrolyte generated by charging and discharging of the secondary battery clings to the surface of the active material, which might cause deterioration of the secondary battery. However, since the electrolyte containing fluorine is smooth, the decomposition product of the electrolyte is less likely to attach to the surface of the active material. Therefore, the deterioration of the secondary battery can be suppressed.

In some cases, a plurality of solvated lithium ions form a cluster in the electrolyte and the cluster moves in the negative electrode, between the positive electrode and the negative electrode, or in the positive electrode, for example.

An example of the fluorinated cyclic carbonate is shown below.

The monofluoroethylene carbonate (FEC) is represented by Formula (1) below.

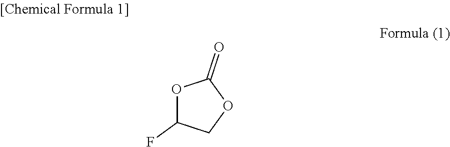

The tetrafluoroethylene carbonate (F4EC) is represented by Formula (2) below.

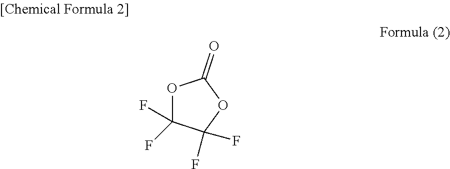

The difluoroethylene carbonate (DFEC) is represented by Formula (3) below.

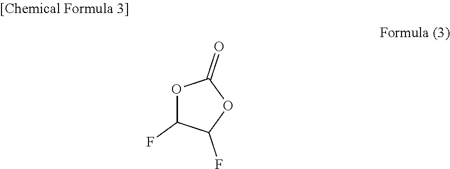

In this specification, an electrolyte is a general term of a solid material, a liquid material, a semi-solid-state material, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. In addition, a structure may be employed in which a binder, a graphene compound, or the like clings to or is held by the electrolyte containing fluorine. Alternatively, an electrolyte containing fluorine may be held in a binder or a graphene compound. This structure can maintain the state where the viscosity of the electrolyte is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly as compared with FEC to which one fluorine atom is bonded. Accordingly, it is possible to reduce attachment of a decomposition product with a high viscosity to an active material particle. When a decomposition product with a high viscosity is attached to or clings to an active material particle, a lithium ion is less likely to move at an interface between active material particles. The electrolyte containing fluorine that solvates lithium reduces generation of a decomposition product that is to be attached to the surface of the active material (the positive electrode active material or the negative electrode active material). Moreover, the use of the electrolyte containing fluorine can prevent attachment of a decomposition product, which can prevent generation and growth of a dendrite.

The use of the electrolyte containing fluorine as a main component is also a feature, and the amount of the electrolyte containing fluorine is higher than or equal to 5 volume %, or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

Furthermore, an additive agent such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more of aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the polymer material, for example, one or more selected from a polymer having a polyalkylene oxide structure, such as polyethylene oxide (PEO); PVDF; polyacrylonitrile; and a copolymer containing any of them can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery and an all-solid-state battery can be fabricated.

In this specification and the like, a layer provided between a positive electrode and a negative electrode is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of an electrolyte layer, a positive electrode, and a negative electrode includes a semi-solid-state material. The semi-solid-state here does not mean that the proportion of a solid-state material is 50%. The semi-solid-state means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery fabricated using the negative electrode of one embodiment of the present invention is a secondary battery having high charge and discharge capacity. The semi-solid-state battery can have high charge and discharge voltages. In addition, a highly safe or reliable semi-solid-state battery can be provided.

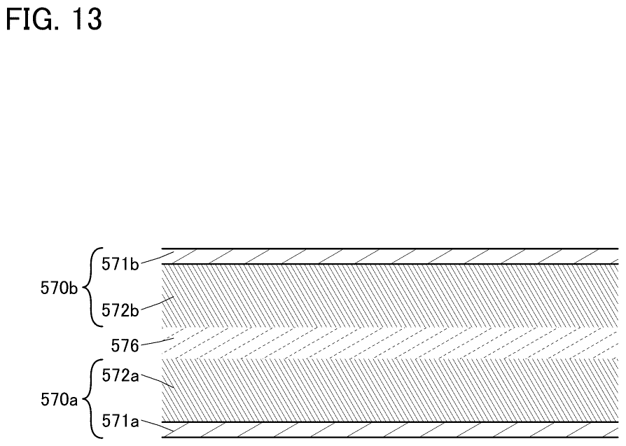

Here, an example in which a semi-solid-state battery is fabricated will be described with reference to FIG. 13.

FIG. 13 is a schematic cross-sectional view of a secondary battery of one embodiment of the present invention. The secondary battery of one embodiment of the present invention includes the negative electrode 570a and the positive electrode 570b. The negative electrode 570a includes at least the negative electrode current collector 571a and the negative electrode active material layer 572a formed in contact with the negative electrode current collector 571a, and the positive electrode 570b includes at least the positive electrode current collector 571b and the positive electrode active material layer 572b formed in contact with the positive electrode current collector 571b. The secondary battery includes the electrolyte 576 between the negative electrode 570a and the positive electrode 570b.

The electrolyte 576 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound containing a polar group to which cations can be coordinated. As the polar group, an ether group, an ester group, a nitrile group, a carbonyl group, siloxane, or the like is preferably included.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions melt to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590×10⁻¹⁰ m in the case of tetracoordination, 0.76×10⁻¹⁰ m in the case of hexacoordination, and 0.92×10⁻¹⁰ m in the case of octacoordination. The radius of a bivalent oxygen ion is 1.35×10⁻¹⁰ m in the case of bicoordination, 1.36×10⁻¹⁰ m in the case of tricoordination, 1.38×10⁻¹⁰ m in the case of tetracorrdination, 1.40×10⁻¹⁰ m in the case of hexacoordination, and 1.42×10⁻¹⁰ m in the case of octacoordination. The distance between polar groups included in adjacent lithium-ion conductive polymer chains is preferably greater than or equal to the distance that allows lithium ions and anion ions contained in the polar groups to exist stably while the above ionic radius is maintained. Furthermore, the distance between the polar groups is preferably a distance that causes sufficient interaction between the lithium ions and the polar groups. Note that the distance is not necessarily always kept constant because the segmental motion occurs as described above. It is acceptable to obtain an appropriate distance for the passage of lithium ions.

As the lithium salt, for example, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LiN(FSO₂)₂ (lithiumbis(fluorosulfonyl)amide, LiFSA), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂ (lithiumbis(trifluoromethanesulfonyl)amide, LiTFSA), LiN(C₄F₉SO₂)(CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSA because favorable characteristics at low temperatures can be obtained. Note that LiFSA and LiTFSA are less likely to react with water than LiPF₆ or the like. This can relax the dew point control in fabricating an electrode and an electrolyte layer that use LiFSA. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSA and LiTFSA, in which case the operating temperature range can be wide.

In this specification and the like, a binder refers to a high molecular compound mixed only for binding an active material, a conductive material, and the like onto a current collector. A binder refers to, for example, a rubber material such as poly vinylidene difluoride (PVDF), styrene-butadiene rubber (SBR), styrene-isoprene-styrene rubber, butadiene rubber, or ethylene-propylene-diene copolymer; or a material such as fluorine rubber, polystyrene, polyvinyl chloride, polytetrafluoroethylene, polyethylene, polypropylene, polyisobutylene, or an ethylene-propylene-diene polymer.

Since the lithium-ion conductive polymer is a high molecular compound, the active material and the conductive material can be bound onto the current collector when the lithium-ion conductive polymer is sufficiently mixed in the active material layer. Thus, the electrode can be fabricated without a binder. A binder is a material that does not contribute to charge and discharge reactions. Thus, a smaller number of binders enable higher proportion of materials that contribute to charging and discharging, such as an active material and an electrolyte. As a result, the secondary battery can have higher discharge capacity, improved cycle performance, or the like.

When containing no or extremely little organic solvent, the secondary battery can be less likely to catch fire and ignite and thus can have higher level of safety, which is preferable. When the electrolyte 576 is an electrolyte layer containing no or extremely little organic solvent, the electrolyte layer can have enough strength and thus can electrically insulate the positive electrode from the negative electrode without a separator. Since a separator is not necessary, the secondary battery can have high productivity. When the electrolyte 576 is an electrolyte layer containing an inorganic filler, the secondary battery can have higher strength and higher level of safety.

The electrolyte layer is preferably dried sufficiently so that the electrolyte 576 can be an electrolyte layer containing no or extremely little organic solvent. In this specification and the like, the electrolyte layer can be regarded as being dried sufficiently when a change in the weight after drying at 90° C. under reduced pressure for one hour is within 5%.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the active material layer is subjected to suspension using a solvent to separate the active material from the other materials.

Moreover, in each of the above structures, a solid electrolyte material may be further contained in the negative electrode to increase incombustibility. As the solid electrolyte material, an oxide-based solid electrolyte is preferably used.

Examples of the oxide-based solid electrolyte are lithium composite oxides and lithium oxide materials such as LiPON, Li₂O, Li₂CO₃, Li₂MoO₄, Li₃PO₄, Li₃VO₄, Li₄SiO₄, LLT(La_{2/3-x}Li₃ₓTiO₃), and LLZ(Li₇La₃Zr₂O₁₂).

LLZ is a garnet-type oxide containing Li, La, and Zr and may be a compound containing Al, Ga, or Ta.

Alternatively, a polymer solid electrolyte such as PEO (polyethylene oxide) formed by an application method or the like may be used. Such a polymer solid electrolyte can also function as a binder; thus, in the case of using a polymer solid electrolyte, the number of components of the electrode can be reduced and the manufacturing cost can also be reduced.

This embodiment can be implemented in appropriate combination with any of the other embodiments.

### Embodiment 2

In this embodiment, examples of a secondary battery of one embodiment of the present invention are described.

### <Structure Example 1 of Secondary Battery>

Hereinafter, a secondary battery in which a positive electrode, a negative electrode, and an electrolyte are wrapped in an exterior body is described as an example.

### [Negative Electrode]

The negative electrode described in the above embodiment can be used as the negative electrode.

### [Current Collector]

For each of a positive electrode current collector and a negative electrode current collector, it is possible to use a material which has high conductivity and is not alloyed with carrier ions such as lithium, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions such as lithium is preferably used for the negative electrode current collector.

As the current collector, a titanium compound may be stacked over the above-described metal element. As a titanium compound, for example, it is possible to use one selected from titanium nitride, titanium oxide, titanium nitride in which part of nitrogen is substituted by oxygen, titanium oxide in which part of oxygen is substituted by nitrogen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

### [Positive Electrode]

The positive electrode includes a positive electrode active material layer and the positive electrode current collector. The positive electrode active material layer includes a positive electrode active material, and may include a conductive material and a binder.

For the conductive material and the binder that can be included in the positive electrode active material layer, materials similar to those of the conductive material and the binder that can be included in the negative electrode active material layer can be used.

### [Separator]

A separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator is a porous material having a hole with a size of approximately 20 nm, preferably a hole with a size of greater than or equal to 6.5 nm, further preferably a hole with a diameter of at least 2 nm. In the case of the above-described semi-solid-state secondary battery, the separator can be omitted.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be inhibited and thus the reliability of the secondary battery can be improved. When the separator is coated with the fluorine-based material, the separator is easily in close contact with an electrode, resulting in high output characteristics. When the separator is coated with the polyamide-based material, especially, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, one or more selected from metal materials such as aluminum and resin materials can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

This embodiment can be implemented in appropriate combination with any of the other embodiments.

### Embodiment 3

This embodiment will describe examples of shapes of several types of secondary batteries including a positive electrode or a negative electrode formed by the fabrication method described in the foregoing embodiment.

### [Coin-Type Secondary Battery]

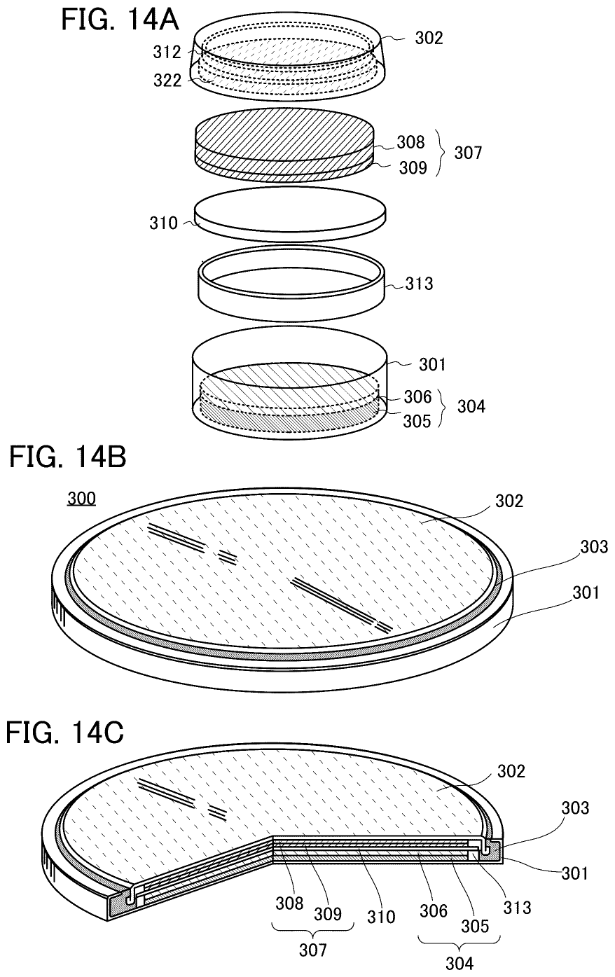

An example of a coin-type secondary battery is described. FIG. 14A is an exploded perspective view of a coin-type (single-layer flat type) secondary battery, FIG. 14B is an external view, and FIG. 14C is a cross-sectional view thereof. Coin-type secondary batteries are mainly used in small electronic devices.

For easy understanding, FIG. 14A is a schematic view illustrating overlap (a vertical relation and a positional relation) between components. Thus, FIG. 14A and FIG. 14B do not completely correspond with each other.

In FIG. 14A, a positive electrode 304, a separator 310, a negative electrode 307, a spacer 322, and a washer 312 are overlaid. These components are sealed with a negative electrode can 302 and a positive electrode can 301. Note that a gasket for sealing is not illustrated in FIG. 14A. The spacer 322 and the washer 312 are used to protect the inside or fix the position inside the cans at the time when the positive electrode can 301 and the negative electrode can 302 are bonded with pressure. For each of the spacer 322 and the washer 312, stainless steel or an insulating material is used.

The positive electrode 304 has a stack structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 14B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 may be provided with an active material layer.

For the positive electrode can 301 and the negative electrode can 302, a material having corrosion resistance to an electrolyte can be used. For example, a metal such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 14C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity, and excellent cycle performance. Note that in the case of a secondary battery, the separator 310 is not necessarily provided between the negative electrode 307 and the positive electrode 304.

### [Cylindrical Secondary Battery]

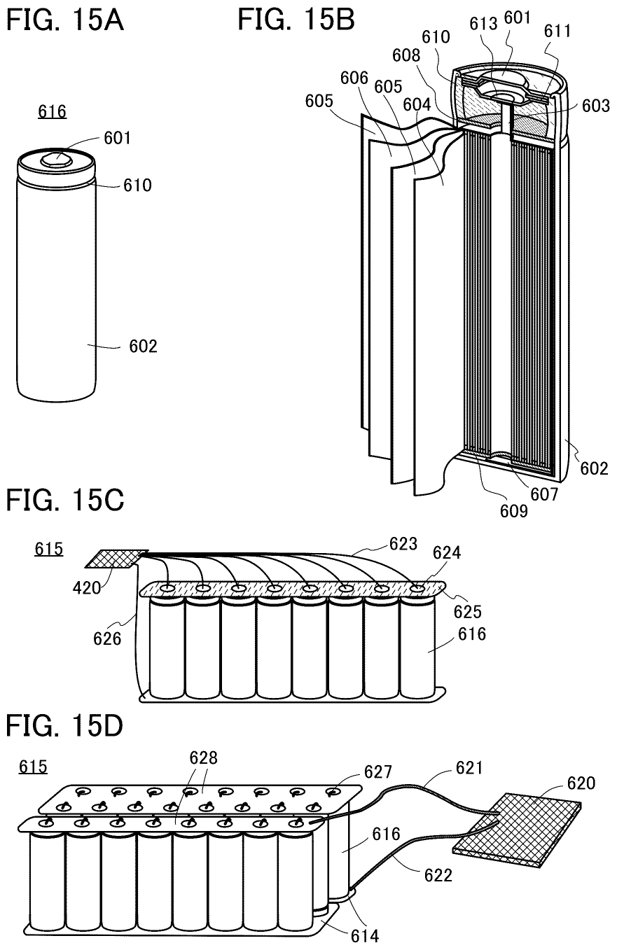

An example of a cylindrical secondary battery is described with reference to FIG. 15A. As illustrated in FIG. 15A, a cylindrical secondary battery 616 includes a positive electrode cap (battery cap) 601 on the top surface and a battery can (outer can) 602 on the side surface and bottom surface. The battery can (outer can) 602 is formed of a metal material and has an excellent barrier property against water permeation and an excellent gas barrier property. The positive electrode cap 601 and the battery can (outer can) 602 are insulated from each other by a gasket (insulating gasket) 610.

FIG. 15B schematically illustrates a cross section of a cylindrical secondary battery. The cylindrical secondary battery illustrated in FIG. 15B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a material having corrosion resistance to an electrolyte can be used. For example, a metal such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The negative electrode obtained in Embodiment 1 is used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. For both the positive electrode terminal 603 and the negative electrode terminal 607, a metal material such as aluminum can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 15C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like and a protection circuit for preventing overcharging or overdischarging can be used. The control circuit 620 has a function of performing one or more of controlling charging, controlling discharging, measuring charge voltage, measuring discharge voltage, measuring charge current, measuring discharge current, and measuring remaining capacity by accumulation of charge amount, for example. Moreover, the control circuit 620 has a function of performing one or more of detecting overcharging, detecting overdischarging, detecting charge overcurrent, and detecting discharge overcurrent, for example. The control circuit 620 preferably has a function of performing one or more of stopping charging, stopping discharging, changing a charging condition, and changing a discharging condition, on the basis of the results of the above-described detection.

FIG. 15D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in parallel and then be further connected in series.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 15D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

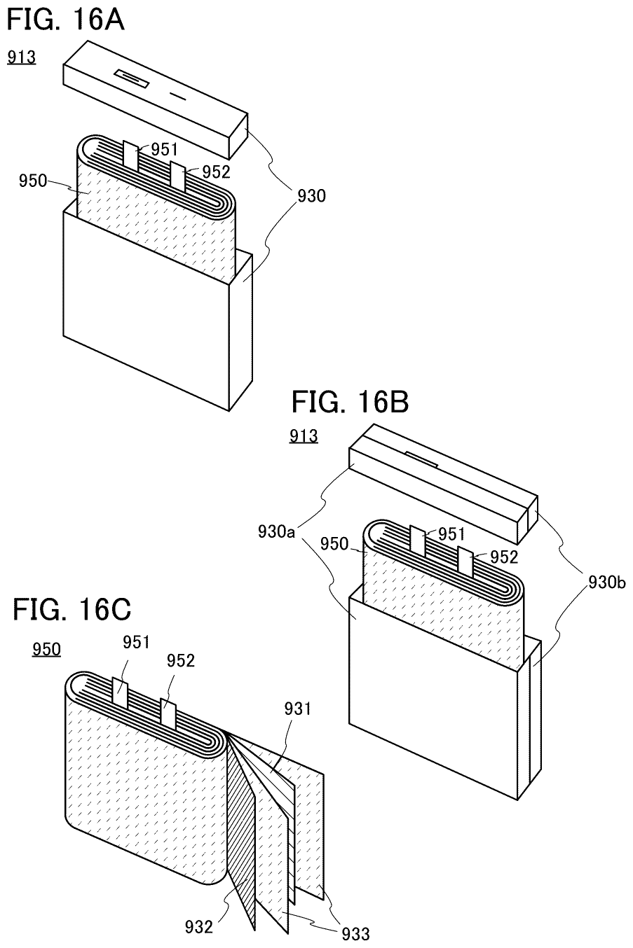

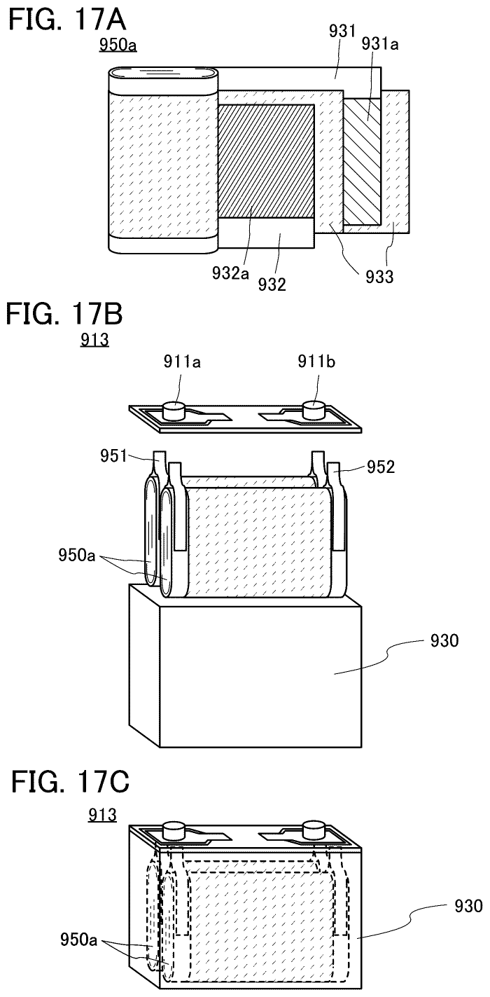

Structure examples of secondary batteries are described with reference to FIG. 16 and FIG. 17.

A secondary battery 913 illustrated in FIG. 16A includes a wound body 950 provided with a terminal 951 and a terminal 952 inside a housing 930. The wound body 950 is immersed in an electrolyte inside the housing 930. The terminal 952 is in contact with the housing 930. The terminal 951 is not in contact with the housing 930 with use of an insulator or the like. Note that in FIG. 16A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 16B, the housing 930 in FIG. 16A may be formed using a plurality of materials. For example, in the secondary battery 913 illustrated in FIG. 16B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 16C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 17, the secondary battery 913 may include a wound body 950a. The wound body 950a illustrated in FIG. 17A includes the negative electrode 931, the positive electrode 932, and the separators 933. The negative electrode 931 includes a negative electrode active material layer 931a. The positive electrode 932 includes a positive electrode active material layer 932a.

An electrolyte containing fluorine is used for the negative electrode 931, whereby the secondary battery 913 can have high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 17A and FIG. 17B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 17C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 17B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 16A to FIG. 16C can be referred to for the other components of the secondary battery 913 illustrated in FIG. 17A and FIG. 17B.

### <Laminated Secondary Battery>

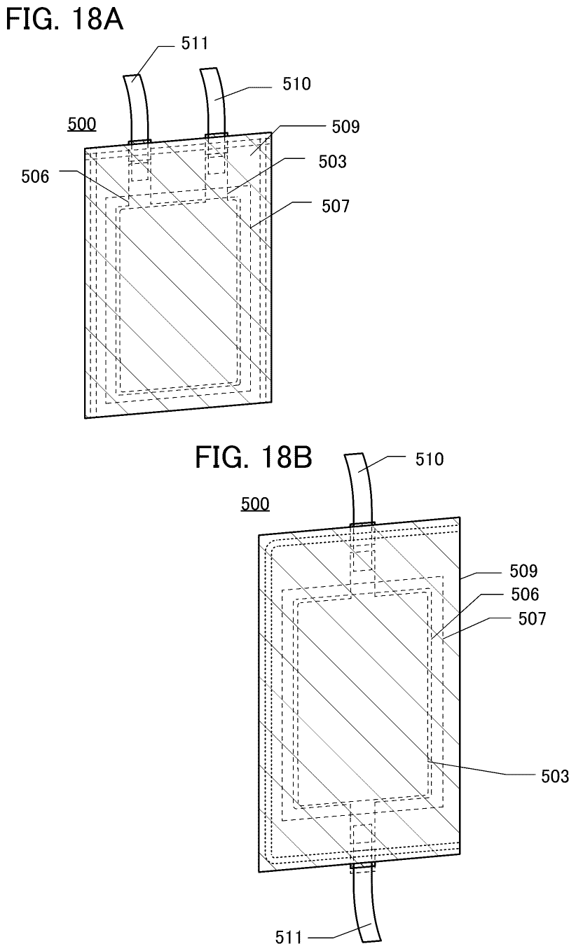

Next, examples of the appearance of a laminated secondary battery are illustrated in FIG. 18A and FIG. 18B. FIG. 18A and FIG. 18B each include a positive electrode 503, a negative electrode 506, a separator 507, an exterior body 509, a positive electrode lead electrode 510, and a negative electrode lead electrode 511.

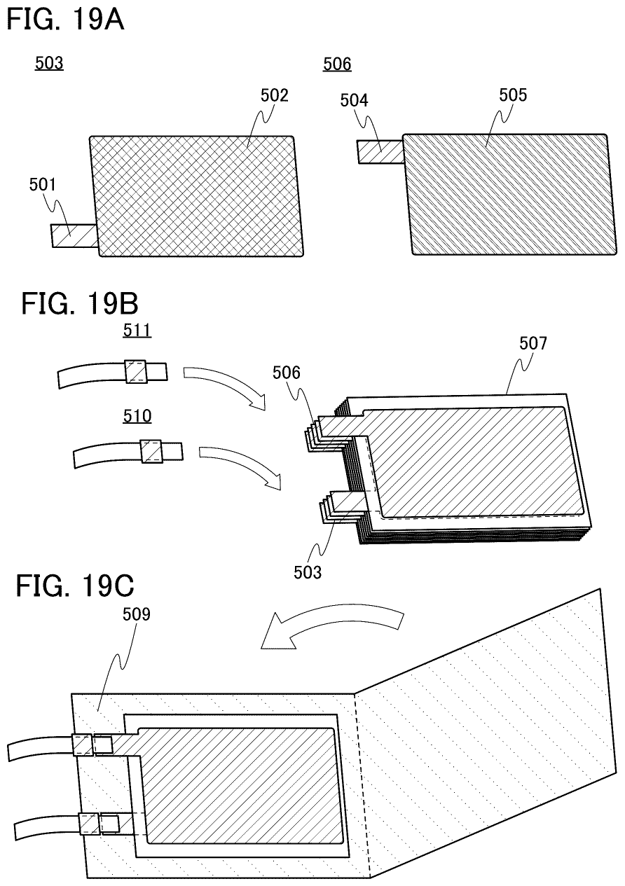

FIG. 19A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 19A.

### <Method for Manufacturing Laminated Secondary Battery>

Here, an example of a method for manufacturing the laminated secondary battery whose external view is illustrated in FIG. 18A will be described with reference to FIG. 19B and FIG. 19C.

First, the negative electrode 506, the separator 507, and the positive electrode 503 are stacked. FIG. 19B illustrates the negative electrodes 506, the separators 507, and the positive electrodes 503 that are stacked. Here, an example in which five negative electrodes and four positive electrodes are used is illustrated. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 19C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte can be introduced later. As the exterior body 509, a film having an excellent barrier property against water permeation and an excellent gas barrier property is preferably used. The exterior body 509 having a stacked-layer structure including metal foil (for example, aluminum foil) as one of intermediate layers can have a high barrier property against water permeation and a high gas barrier property.

Next, the electrolyte (not illustrated) is introduced into the exterior body 509 from the inlet of the exterior body 509. The electrolyte is preferably introduced in a reduced pressure atmosphere or in an inert atmosphere. Lastly, the inlet is sealed by bonding. In this manner, the laminated secondary battery 500 can be manufactured.

The negative electrode structure obtained in Embodiment 1, i.e., an electrolyte containing fluorine is used for the negative electrode 506, whereby the secondary battery 500 can have high capacity, high charge and discharge capacity, and excellent cycle performance.

This embodiment can be implemented in appropriate combination with any of the other embodiments.

### Embodiment 4

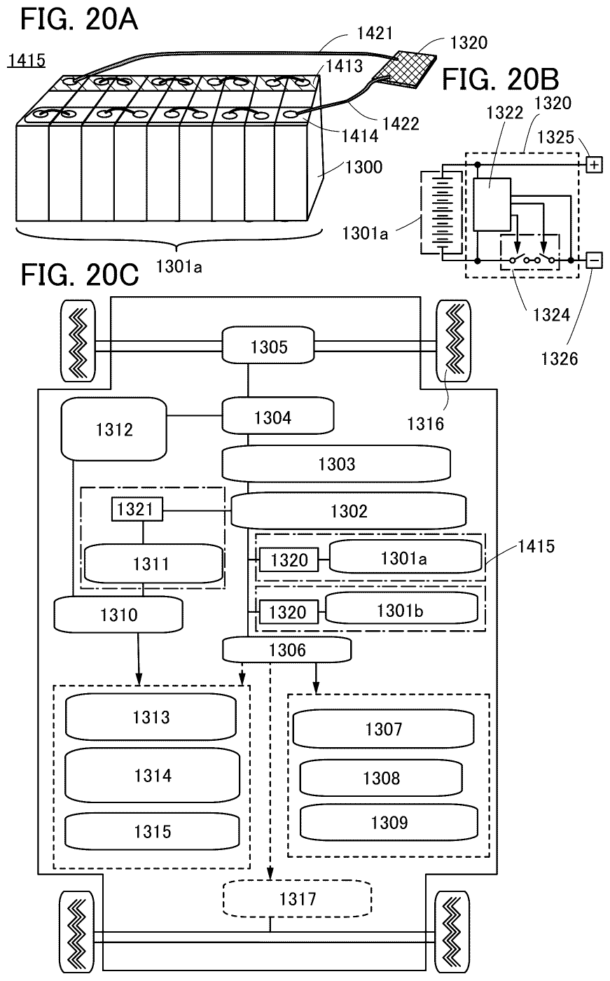

As described below, a secondary battery of one embodiment of the present invention can be provided in a moving vehicle such as an automobile, a train, or an aircraft. In this embodiment, an example different from the cylindrical secondary battery in FIG. 15D will be described. An example of application to an electric vehicle (EV) will be described with reference to FIG. 20C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 16A or the stacked structure illustrated in FIG. 18A and FIG. 18B.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 20A.

FIG. 20A illustrates an example in which nine rectangular secondary batteries 1300 constitute one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment illustrates the example in which the secondary batteries are fixed by the fixing portions 1413 and 1414, the secondary batteries may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414. or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off both an output transistor of a charging circuit and an interruption switch substantially at the same time.

FIG. 20B illustrates an example of a block diagram of the battery pack 1415 illustrated in FIG. 20A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from one or both of a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

Mounting the secondary battery illustrated in FIG. 15D or FIG. 20A on vehicles can provide next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and can be favorably used in transport vehicles.

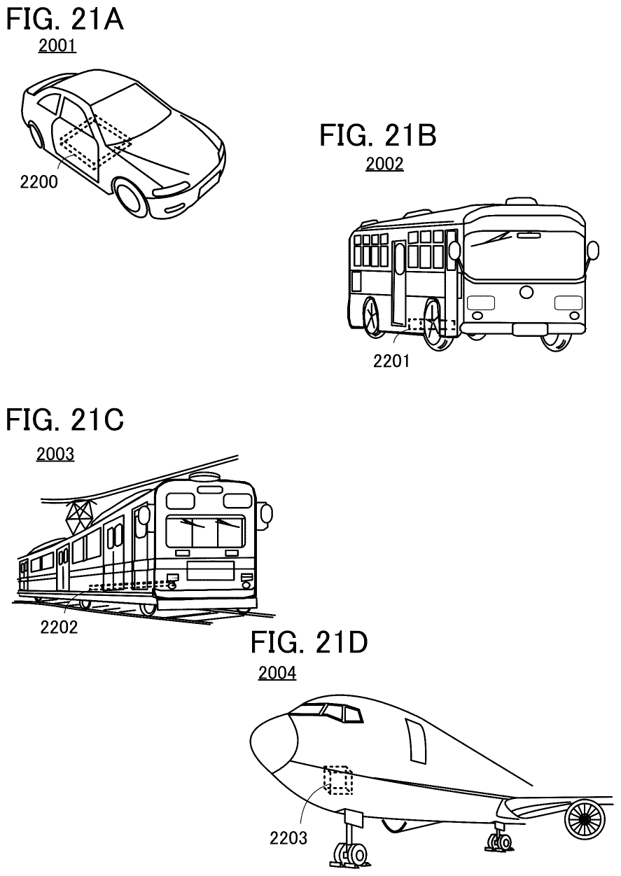

FIG. 21A to FIG. 21D illustrate examples of moving vehicles such as transport vehicles using one embodiment of the present invention. An automobile 2001 illustrated in FIG. 21A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, the secondary battery is provided at one position or several positions. The automobile 2001 illustrated in FIG. 21A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from external charging equipment through one or more of a plug-in system, a contactless charging system, and the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a storage battery incorporated in the automobile 2001. Charging can be performed by converting AC power into DC power through a converter such as an AC-DC converter.

Although not illustrated, the vehicle can include a power receiving device so as to be charged by being supplied with electric power from an above-ground power transmitting device in a contactless manner. For the contactless power feeding system, by fitting a power transmitting device in one or both of a road and an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, one or both of an electromagnetic induction method and a magnetic resonance method can be used.

FIG. 21B illustrates a large transporter 2002 having a motor controlled by electric power, as an example of a transport vehicle. In the secondary battery module of the transporter 2002, a cell unit includes four secondary batteries with a voltage of 3.5 V or higher and 4.7 V or lower, and 48 cells are connected in series to have 170 V as the maximum voltage. A battery pack 2201 has a function similar to that in FIG. 21A except that the number of secondary batteries forming the secondary battery module of the battery pack 2201 or the like is different; thus the description is omitted.

FIG. 21C illustrates a large transport vehicle 2003 having a motor controlled by electricity as an example. In the secondary battery module of the transport vehicle 2003, 100 or more secondary batteries with a voltage of 3.5 V or higher and 4.7 V or lower are connected in series, and the maximum voltage is 600 V, for example. Thus, the secondary batteries are required to have few variations in the characteristics. With use of a secondary battery employing the structure including an electrolyte containing fluorine in a negative electrode, a secondary battery having stable battery characteristics can be manufactured and its high-volume production at low costs is possible in light of the yield. A battery pack 2202 has a function similar to that in FIG. 21A except that the number of secondary batteries forming the secondary battery module of the battery pack 2202 or the like is different; thus the detailed description is omitted.

FIG. 21D illustrates an aircraft 2004 having a combustion engine as an example. The aircraft 2004 illustrated in FIG. 21D can be regarded as a portion of a transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 21A except that the number of secondary batteries constituting the secondary battery module of the battery pack 2203 or the like is different; thus the detailed description is omitted.

This embodiment can be implemented in appropriate combination with any of the other embodiments.

### Embodiment 5

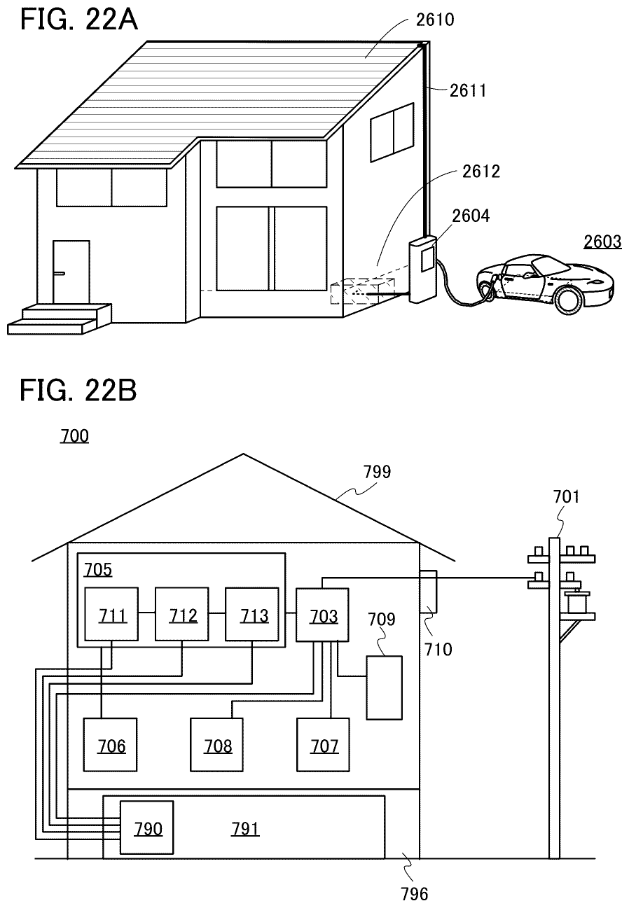

In this embodiment, examples in which the secondary battery of one embodiment of the present invention is mounted on a building will be described with reference to FIG. 22A and FIG. 22B.

A house illustrated in FIG. 22A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charging equipment 2604. The power storage device 2612 can be charged with electric power generated by the solar panel 2610. The secondary battery included in the vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 22B illustrates an example of a power storage device 700 of one embodiment of the present invention. As illustrated in FIG. 22B, a power storage device 791 of one embodiment of the present invention is provided in an underfloor space 796 of a building 799.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 6

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

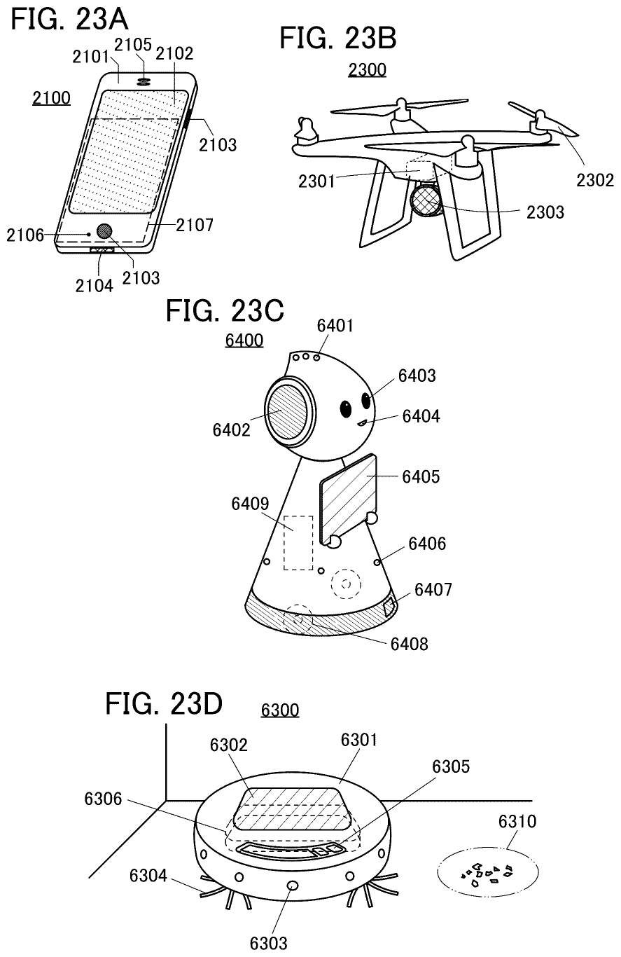

FIG. 23A illustrates an example of a mobile phone. A mobile phone 2100 includes a display portion 2102 set in a housing 2101, an operation button 2103, an external connection port 2104, a speaker 2105, a microphone 2106, and the like. The mobile phone 2100 includes a secondary battery 2107. The use of the secondary battery 2107 having the structure including an electrolyte containing fluorine in a negative electrode can achieve high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by an operating system incorporated in the mobile phone 2100.

The mobile phone 2100 can employ near field communication based on a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, one or more selected from a human body sensor such as a fingerprint sensor, a pulse sensor, and a temperature sensor, a touch sensor, a pressure sensitive sensor, an acceleration sensor, and the like is preferably mounted, for example.

FIG. 23B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery employing the structure including an electrolyte containing fluorine in a negative electrode has high energy density and a high degree of safety, and thus can be used safely for a long time over a long period of time and is suitable for the secondary battery used in the unmanned aircraft 2300.

FIG. 23C illustrates an example of a robot. A robot 6400 illustrated in FIG. 23C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user, using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery employing the structure including an electrolyte containing fluorine in a negative electrode has high energy density and a high degree of safety, and thus can be used safely for a long time over a long period of time and is suitable for the secondary battery 6409 included in the robot 6400.

FIG. 23D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery employing the structure including an electrolyte containing fluorine in a negative electrode has high energy density and a high degree of safety, and thus can be used safely for a long time over a long period of time and is suitable for the secondary battery 6306 included in the cleaning robot 6300.

This embodiment can be implemented in appropriate combination with the other embodiments.

<Notes on Description of this Specification and the Like>

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (−) at the front of a number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is preferably a region that is less than or equal to 50 nm, preferably less than or equal to 35 nm, further preferably less than or equal to 20 nm from the surface, for example. A plane generated by a split or a crack may also be referred to as a surface. In addition, a region in a deeper position than a surface portion is referred to as an inner portion.

In this specification and the like, the layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, an O3′ type crystal structure of a composite oxide containing lithium and a transition metal belongs to the space group R-3m, and is not a spinel crystal structure but a crystal structure in which an ion of cobalt, magnesium, or the like is coordinated to six oxygen atoms and the cation arrangement has symmetry similar to that of the spinel crystal structure.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the depth of charge obtained when all the lithium that can be inserted and extracted is inserted is 0, and the depth of charge obtained when all the lithium that can be inserted and extracted in a positive electrode active material is extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a depth of charge of greater than or equal to 0.7 and less than or equal to 0.9 may be referred to as a positive electrode active material charged with high voltage.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. Furthermore, a positive electrode active material with a charge depth of 0.06 or less or a positive electrode active material from which 90% or more of the charge capacity in a high-voltage charged state is discharged is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

### Example 1

In this example, an electrode of one embodiment of the present invention was formed and a coin cell in which the formed electrode and a lithium electrode were combined was fabricated, and the characteristics were evaluated.

As silicon, silicon particles produced by ALDRICH were used (hereinafter, Sample nSi-1). The silicon particles were soaked in buffered fluoric acid (mixed solution of hydrofluoric acid and ammonium fluoride) and washed with pure water, and heat treatment was performed in a reduced-pressure atmosphere at 100° C. for one hour, and thereby Sample nS-2 was obtained.

### <EDX>

Next, SEM-EDX analysis was performed on Sample nSi-1 and Sample nSi-2. The results are shown in Table 5. For the EDX measurement, SU8030 produced by Hitachi High-Technologies Corporation equipped with an EDX unit, EX-350X-MaX80 produced by HORIBA, Ltd. was used. The accelerating voltage was set to 10 kV in the EDX analysis. Table 5 shows the results of EDX analysis. Atomic number concentration (atomic %) is used as the unit. Note that the sum of the atomic number concentrations of carbon, oxygen, and silicon atoms is set to 100 atomic %.

TABLE 5
[Atomic %]

| | nSi-1 | nSi-2 |
|---|---|---|
| C | 30.04 | 22.55 |
| O | 27.96 | 4.86 |
| Si | 42.00 | 72.59 |

### <ToF-SIMS>

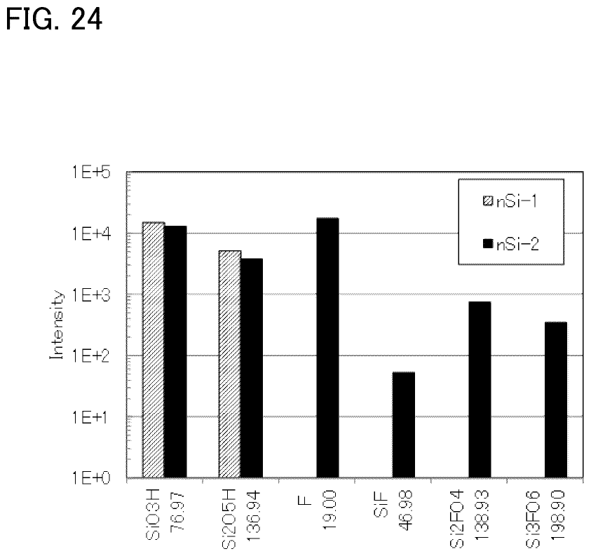

Next, ToF-SIMS analysis was performed on Sample nSi-1 and Sample nSi-2. As the apparatus, TOF.SIMS5 produced by ION-TOF was used and bismuth was used as a primary ion source. FIG. 24 shows the results. The vertical axis represents intensity (Intensity). In EDX, from Sample nSi-1 with a higher concentration of oxygen, negative ions probably resulting from SiO₃H and Si₂O₅H were mainly detected, which suggests the existence of silicon, oxygen, and hydrogen. On the other hand, negative ions probably resulting from F, SiF, Si₂FO₄, and Si₃FO₆ were detected from Sample nSi-2, as well as SiO₃H and Si₂O₅H, which suggests, for example, the existence of fluorine and a bond between silicon and fluorine in the sample surface. This is because hydrofluoric acid treatment was performed in Sample nSi-2. Note that a contribution of a ghost peak is included in F, SiF, Si₂FO₄, and Si₃FO₆.

### <Electrode Formation>

Next, in accordance with the flow chart in FIG. 10, electrodes were formed using Sample nSi-1 and Sample nSi-2.

The particle containing silicon (Sample nSi-1 or Sample nSi-2) and a solvent were prepared at 1:1 of the particle containing silicon to the solvent (weight ratio) and mixed (Steps S71, S72, S73). As a solvent, NMP was used. In the mixing, mixing was performed at 2000 rpm for three minutes with use of a planetary centrifugal mixer (Awatori rentaro produced by THINKY CORPORATION) and the mixture was collected to give the mixture E-1 (Steps S74 and S75).

Next, the mixture E-1 and a graphene compound were mixed repeatedly with a solvent added thereto. The weight of the graphene compound was set to 0.0625 times (5/80 times) the weight of the particle containing silicon prepared in Step S71. Graphene oxide was used as the graphene compound. Mixing was performed at 2000 rpm for three minutes with use of the planetary centrifugal mixer and the mixture was collected (Steps S81 and S82). Then, the collected mixture was stiff-kneaded and NMP was added thereto as appropriate, and mixing was performed at 2000 rpm for three minutes with use of the planetary centrifugal mixer and the mixture was collected (Steps S83, S84, and Step S85). Step S83 to Step S85 were repeated five times to give the mixture E-2 (Step S86).

Next, the mixture E-2 and a precursor of polyimide were mixed (Step S88). The weight of the prepared polyimide was set to 0.1875 times (15/80 times) the weight of the particle containing silicon prepared in Step 71. Mixing was performed at 2000 rpm for three minutes with use of the planetary centrifugal mixer. After that, NMP whose weight is 1.5 times that of the particle containing silicon prepared in Step 71 was prepared and added to the mixture so that the viscosity of the mixture was adjusted (Step S89), and further mixing was performed (twice at 2000 rpm for three minutes with use of the planetary centrifugal mixer), the mixture was collected, whereby the mixture E-3 was obtained as a slurry (Steps S90, S91, and S92).

Next, a current collector was prepared and application of the mixture E-3 was performed (Steps S93 and S94). An undercoated copper foil was prepared as the current collector and the mixture E-3 was applied to the copper foil with use of a doctor blade with a gap thickness of 100 μm. The current collector used is the prepared copper foil having a thickness of copper of 18 μm and including a coating layer containing carbon as the undercoat. AB was used as a material in the coating layer containing carbon.

Then, the first heating was performed on the copper foil to which the mixture E-3 was applied at 50° C. for one hour (Step S95). After that, the second heating was performed under reduced pressure at 400° C. for five hours (Step S96), whereby an electrode was formed. By the heating, the graphene oxide is reduced, so that the amount of oxygen is decreased.

### <SEM>

SEM observation of the surface and cross-section of the formed electrode was performed. S-4800 produced by Hitachi High-Technologies Corporation was used as SEM. The accelerating voltage was 5 kV. The electrode subjected to cross-section observation had been processed by an ion milling method before the observation so as to be exposed on its cross-section.

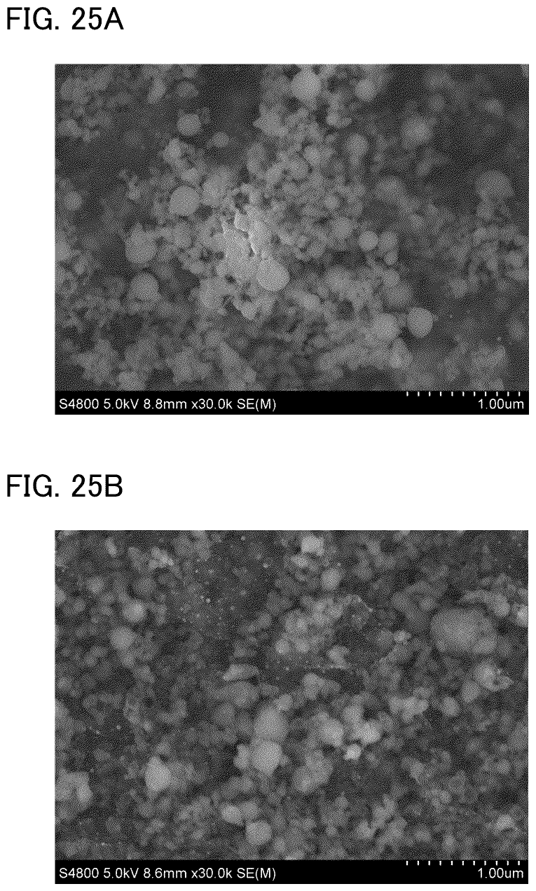

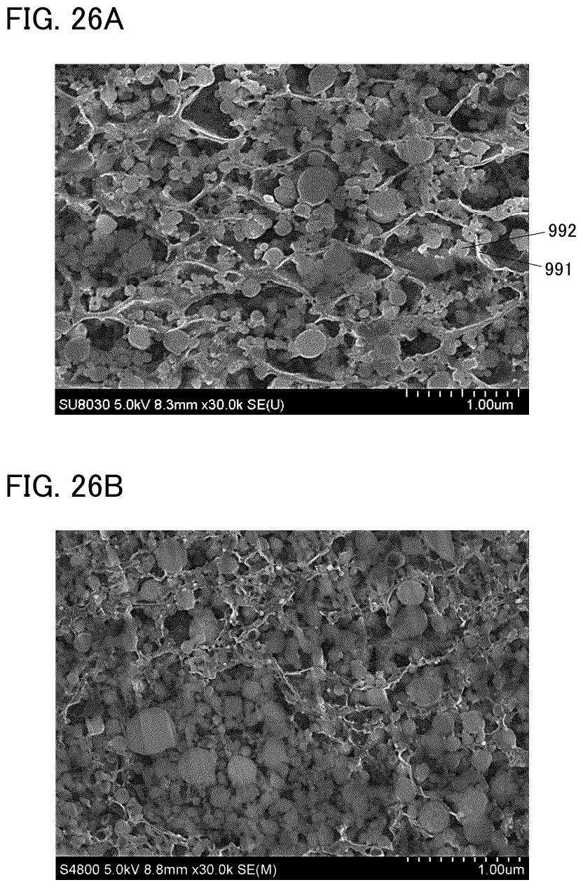

FIG. 25A and FIG. 26A are observation images of the surface and the cross-section, respectively of the electrode formed using Sample nSi-1. FIG. 25B and FIG. 26B are observation images of the surface and the cross-section, respectively of the electrode formed using Sample nSi-2. From the comparison between FIG. 26A and FIG. 26B, it is found that in the electrode using Sample nSi-1, which probably contains oxygen and hydrogen in the surface, a graphene compound 991 forms fine meshes and is dispersed relatively evenly in the electrode. It is also found that the graphene compound 991 has a pouch-like region and a plurality of particles (particles containing silicon) 992 are placed in the pouch.

### <Fabrication of Coin Cell>

Next, using the formed electrode, a CR2032 type coin cell (with a diameter of 20 mm and a height of 3.2 mm) was fabricated.

Lithium metal was used for a counter electrode. An electrolyte was used in which lithium hexafluorophosphate (LiPF₆) was mixed into a mixture of ethylene carbonate (EC) and diethyl carbonate (DEC) with EC:DEC=3:7 (in volume ratio), at a concentration of 1 mol/L.

As a separator, 25-μm-thick polypropylene was used.

A positive electrode can and a negative electrode can that were formed using stainless steel (SUS) were used.

### <Charging and Discharging Characteristics>

The evaluation of charging and discharging characteristics was performed on the fabricated coin cell. In the fabricated coin cell, lithium is occluded in the electrode in discharging and lithium is released from the electrode in charging.

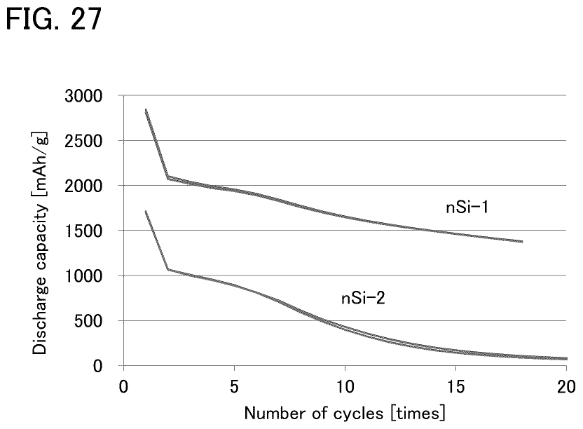

The discharging condition (lithium occlusion) was set to constant current discharging (0.1 C and lower voltage limit of 0.01 V) and then constant voltage discharging (lower current density of 0.01 C), and charging condition (lithium release) was set to constant current charging (0.1 C and upper voltage limit of 1 V). Discharging and charging were performed at 25° C. FIG. 27 shows a change of a capacity depending on the cycle number in charging and discharging cycles. The coin cell using the electrode using Sample nSi-1, probably having oxygen and hydrogen in the surface, suppressed the reduction of the capacity depending on excellent cycle number and achieved excellent characteristics.

### <SEM>

The coin cell using the electrode using Sample nSi-1 was disassembled both after discharging (lithium occlusion) and after charging (lithium release), and the SEM observation of the surface was performed. The coin cell disassembled after discharging and the coin cell disassembled after charging were different coin cells.

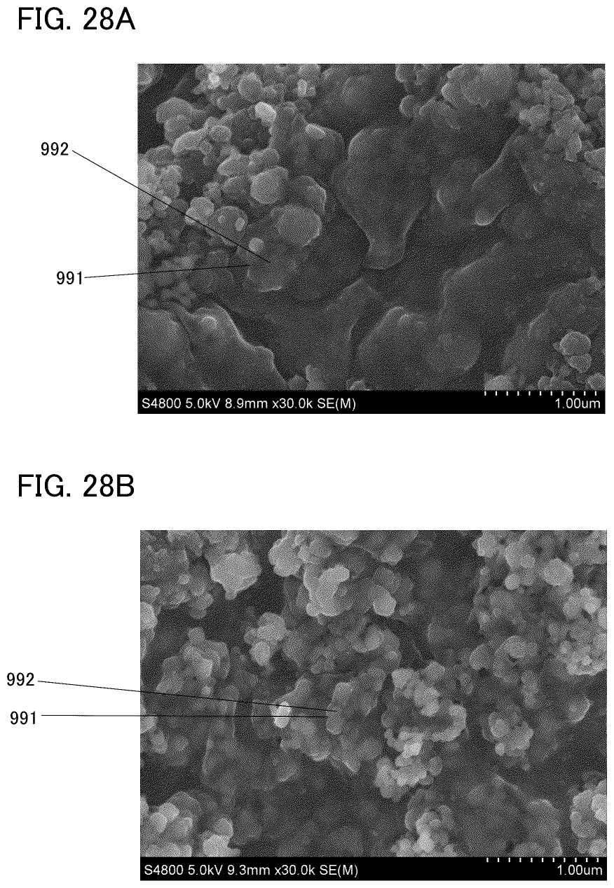

FIG. 28A is a surface image of the electrode of the coin cell disassembled after discharging and FIG. 28B is a surface image of the electrode of the coin cell disassembled after charging. By discharging, it is observed that lithium is occluded in particles containing silicon, and the particles swelled. It is also suggested that a plurality of particles (particles containing silicon) swell and shrink with covered with the graphene compound.

The phrase “the graphene compound clings to a particle containing silicon” indicates the relation between the graphene compound 991 and the particle 992 containing silicon shown in FIG. 28A, and also indicates the relation between the graphene compound 991 and the particle 992 containing silicon shown in FIG. 28B in another example.

### Example 2

In this example, analysis results of electron energy loss spectroscopy (EELS) of an electrode of one embodiment of the present invention are described.

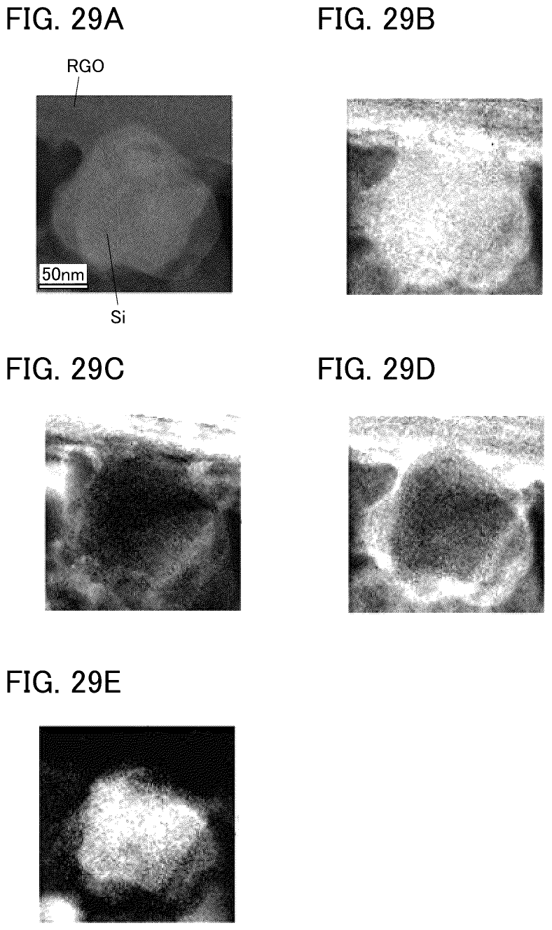

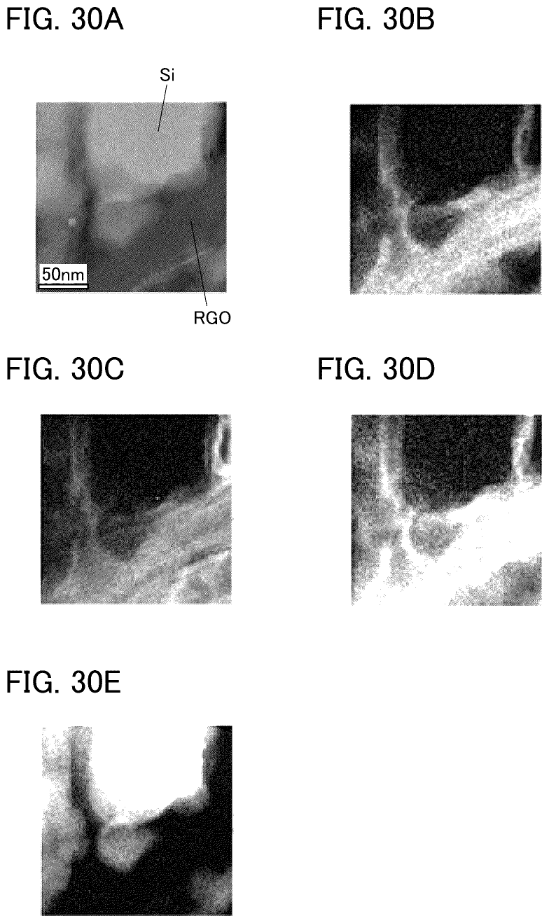

Both after discharging (lithium occlusion) and after charging (lithium release), the coin cells using the electrode using Sample nSi-1 formed in Example 1 were disassembled, and the cross-sectional STEM-EELS surface analysis was performed. Results are shown in FIG. 29A to FIG. 30E.

FIG. 29A to FIG. 29E show analysis results after lithium occlusion. FIG. 29A is an ADF-STEM image and FIG. 29B to FIG. 29E show EELS analysis results corresponding to the ADF-STEM image shown in FIG. 29A. FIG. 29B, FIG. 29C, FIG. 29D, and FIG. 29E show analysis results of Li, C, O, and Si, respectively. Lighter areas show higher concentrations.

In FIG. 29A, “Si” is used to denote a portion corresponding to the particle containing silicon, and “RGO” is used to denote a portion corresponding to the graphene compound. The graphene compound is a compound obtained by performing heat treatment on graphene oxide, and can be considered to be a reduced graphene oxide, for example.

The results of FIG. 29A to FIG. 29E suggest that lithium (Li) exists at the portion corresponding to the particle containing silicon. This shows that the graphene compound probably has permeability to lithium ions. The graphene compound is also considered not to hinder the lithium occlusion process to the particle containing silicon.

FIG. 30A to FIG. 30E show analysis results after lithium release. FIG. 30A is an ADF-STEM image and FIG. 30B to FIG. 30E show EELS analysis results corresponding to the ADF-STEM image shown in FIG. 30A. FIG. 30B, FIG. 30C, FIG. 30D, and FIG. 30E show analysis results of Li, C, O, and Si, respectively.

In FIG. 30A, “Si” is used to denote a portion corresponding to the particle containing silico, and “RGO” is used to denote a portion corresponding to the graphene compound. The graphene compound is a compound obtained by performing heat treatment on graphene oxide, and can be considered to be a reduced graphene oxide, for example.

The results of FIG. 30A to FIG. 30E suggest the lithium concentration of the particle containing silicon. This shows the graphene compound is considered not to hinder the lithium release process from the particle containing silicon. The results of FIG. 30A to FIG. 30E suggest that lithium exists at the portion corresponding to the graphene compound. This shows that it is possible that a lithium ion is occluded between graphene compound layers and the occluded lithium ion is hard to be released from oxide graphene.

### REFERENCE NUMERALS

300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 570: electrode, 570a: negative electrode, 570b: positive electrode, 571: current collector, 571a: negative electrode current collector, 571b: positive electrode current collector, 572: active material layer, 572a: negative electrode active material layer, 572b: positive electrode active material layer, 576: electrolyte, 581: electrolyte, 582: particle, 583: graphene compound, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1300: rectangular secondary battery, 1301a: battery, 1301b: battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transport vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging equipment, 2610: solar panel, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery

1. An electrode comprising:
a particle containing silicon; and
a graphene compound,
wherein at least part of a surface of the particle is terminated by a functional group containing oxygen,
wherein the graphene compound clings to the particle, and
wherein the graphene compound is graphene comprising at least one of a carbon atom terminated by a hydrogen atom and a carbon atom terminated by a fluorine atom in a two-dimensional structure formed with a six-membered ring of carbon.

2. An electrode comprising:
a plurality of particles; and
a graphene compound,
wherein at least part of a surface of each of the plurality of particles is terminated by a functional group containing oxygen,
wherein the graphene compound contains the plurality of particles so as to cover the surrounding of the plurality of particles, and
wherein the graphene compound is graphene comprising at least one of a carbon atom terminated by a hydrogen atom and a carbon atom terminated by a fluorine atom in a two-dimensional structure formed with a six-membered ring of carbon.

3. An electrode comprising:
a plurality of particles; and
a graphene compound,
wherein at least part of a surface of each of the plurality of particles is terminated by a functional group containing oxygen,
wherein the graphene compound has a pouch-like shape containing the plurality of particles, and
wherein the graphene compound is graphene comprising at least one of a carbon atom terminated by a hydrogen atom and a carbon atom terminated by a fluorine atom in a two-dimensional structure formed with a six-membered ring of carbon.

4. The electrode according to claim 1,
wherein the functional group is a hydroxy group, an epoxy group, or a carboxy group.

5. An electrode comprising:
a particle containing silicon; and
a graphene compound having a vacancy,
wherein at least part of a surface of the particle is terminated by a functional group containing oxygen,
wherein the graphene compound comprises a plurality of carbon atoms and one or more hydrogen atoms,
wherein each of the one or more hydrogen atoms terminates any one of the plurality of carbon atoms, and
wherein the vacancy is formed with the plurality of carbon atoms and the one or more hydrogen atoms.

6. The electrode according to claim 5,
wherein the functional group is a hydroxy group, an epoxy group, or a carboxy group.

7. A secondary battery comprising:
the electrode according to claim 1, and
an electrolyte.

8. A moving vehicle comprising the secondary battery according to claim 7.

9. An electronic device comprising the secondary battery according to claim 7.

10. The electrode according to claim 2,
wherein the functional group is a hydroxy group, an epoxy group, or a carboxy group.

11. The electrode according to claim 3,
wherein the functional group is a hydroxy group, an epoxy group, or a carboxy group.
